(19) United States
(12) Patent Application Publication
(10) Pub. No.: US 2021/0303818 A1
(43) Pub. Date: Sep. 30, 2021

(54) Systems And Methods For Applying Machine Learning to Analyze Microcopy Images in High-Throughput Systems

(71) Applicants: The Regents of the University of Colorado, a body Corporate, Denver, CO (US); Ursa Analytics, Inc., Denver, CO (US)

(72) Inventors: Theodore W. Randolph, Niwot, CO (US); Austin Lewis Daniels, Littleton, CO (US); Christopher P. Calderon, Denver, CO (US)

(21) Appl. No.: 17/264,690

(22) PCT Filed: Jul. 30, 2019
(86) PCT No.: PCT/US2019/044056

§ 371 Date: Jan. 29, 2021

Related U.S. Application Data
(60) Provisional application No. 62/712,970, filed on Jul. 31, 2018.

(51) Int. Cl. G06K 9/00; G01N 15/14; G06N 3/04

(52) U.S. Cl. CPC G06K 9/0014; G06K 9/00147; G01N 2015/1006; G06N 3/0454; G01N 15/1475

(57) ABSTRACT

The current invention describes systems, methods and apparatus for the combination of high-throughput flow imaging microscopy coupled with convolutional neural networks to analyze particles, such as aggregated biomolecules, and cells for use in in a variety of diagnostic, therapeutic and industrial applications.

### CROSS-REFERENCE TO RELATED APPLICATIONS

This International PCT Application claims the benefit of and priority to U.S. Provisional Application No. 62/712,970, filed Jul. 31, 2018. The entire specification and figures of the above-referenced application is hereby incorporated, in its entirety by reference.

### STATEMENT OF FEDERALLY SPONSORED RESEARCH

This invention was made with government support under grant numbers EB006006 and GM130513 awarded by the National Institutes of Health. The U.S. government has certain rights in the invention.

### TECHNICAL FIELD

Aspects of the present invention relate to systems and methods of analysis of imaging data and assessment of imaged samples to detect, diagnose, and monitor harmful particulate matter such as foreign infectious microorganisms in bodily fluids, particulate contaminants in water or aggregated proteins within biopharmaceutical preparations for example as part of quality control for injectable protein therapeutics and the like.

### BACKGROUND

High-throughput analysis of microscopy images has numerous potential applications in the healthcare and biopharmaceutical fields. One example is the analysis of cells within mammalian blood samples. In this application, the timely diagnosis of pathogenic cells, such as bacteria and viruses, or rare mammalians cells potentially associated with disease, is hindered by the low throughput of conventional microscopy and other cell identification techniques. Even when automated microscope slide readers are employed, the throughput is limited by sample preparation time, the need to apply time-consuming staining techniques, the small volume of sample that can be analyzed per microscope slide, and the challenges of detecting and identifying rare mammalian cells or minute levels of foreign infectious microorganisms within the vast numbers of normal cells found in blood samples. In order to detect and identify small populations of foreign infectious microorganisms, blood samples must typically be cultured to allow the number of foreign infectious microorganisms to increase to more readily detectable levels, a process that can require multiple days of blood culturing and further limit throughput. Thus, identification of pathogens within blood samples often takes days and involves complicated procedures, a situation that may unduly delay effective treatment such as the appropriate selection of an antibiotic. In some instances, these delays have proved to be fatal to patients or have caused unnecessary suffering. A common practice in treating infected patients is the use of broad-spectrum antibiotics. However, due to the problem of bacterial resistance to many antibiotics, broad-spectrum antibiotics may not effectively treat many infections. Further, for same patient populations such as premature neonates, side effects from inappropriately applied or unnecessary antibiotics may put these patients at risk for severe complications. Many cases of infectious disease can be prevented or more effectively and promptly treated if rapid and accurate diagnosis is available. Thus, there is a need for rapid and accurate methods for identifying infectious pathogens based on biological samples.

To detect rare mammalian cells within blood, additional low throughput analyses may be conducted that utilize cell-specific stains and labels in conjunction with fluorescence activated cell sorting (FACS) and other flow cytometry techniques. The low throughput of FACS techniques raises the effective limit of detection for rare cells within blood samples, limiting the ability to diagnose and treat associated disease states. Thus, there is a need for rapid and accurate methods for identifying rare cells within blood samples.

In another promising application of high-throughput image analysis, the aim is to monitor the quality and stability of protein therapeutic drugs. Protein therapeutics are popular and widely growing drug class, but the drug container, storage environment, transportation mechanism, and/or processing conditions in manufacturing can cause a variety of unintended, harmful protein aggregates to form in the drug product. Some protein aggregates can cause a decrease in efficacy of the expensive biopharmaceutical product and some aggregates can even cause adverse drug reactions such as unwanted immune responses, anaphylaxis, infusion reactions, complement activation, and even death. Other types of particulate contaminants, such as glass lamellae that slough off of glass container surfaces and silicone oil droplets that leach from lubricating layers in prefilled syringes can also cause adverse effects, and must be carefully monitored within drug products and drug substance materials. Hence it is crucial to monitor, detect, and classify protein aggregates in drug products and drug substances quickly. Current regulatory methods and criteria are ill-equipped to identify, detect, and characterize these problematic protein aggregates and contaminating particles.

In still another promising application of high-throughput image analysis, the aim is to monitor the phenotypical characteristics of cells that are grown in culture, such as mammalian cells, bacterial cells, insect cells, yeast or fungal cells. As a result of cell culture conditions such as dissolved oxygen levels, agitation levels, nutrient levels and evolutionary pressures, cells in culture may exhibit phenotypical responses that are considered undesirable. For example, growth rates may be slowed, cell survival rates may diminish, production of desired biological products (e.g., protein therapeutics) may decrease, plasmids directing production of biological products may be lost, and therapeutic products may exhibit undesirable post-translational modifications such as altered glycosylation patterns. It would be desirable to rapidly detect and/or identify any cell culture process upset leading to undesirable phenotypic characteristics so corrective action can be taken. For example, it would be desirable to rapidly analyze cells that are producing a glycosylated protein product to detect product of product with an incorrect glycosylation pattern, in order to rapidly adjust nutrient and dissolved oxygen levels so as to maintain the correct glycosylation state.

Attempts have been made to addresses these concerns but have fallen short for a number of technical reasons. For example, Smith et al., (10,255,693) describes a method for detecting and classifying particles found on traditional microscopy slides collected using a low number of repeat magnifications on a single slide. While Smith does implement some neural network-based applications, the system is designed for analyzing a small number of images characterizing a single slide and requires a priori knowledge of the type of objects of interest, Smith also requires detailed label annotation instead of flow microscopy settings not requiring the detailed label annotation of each image, thus limiting its throughput, effectiveness and commercial applicability. In another example, Krause et al., (10,303,979) describes a Convolutional Neural Network-based analysis for analyzing microscopy images in order to identify the contents of the slide as well as to segment the images into individual cells and cell types. Again, this application does not allow for real-time imagining and analysis of flow microscopy nor does it allow one to statistically verify confidence in known particles or identify faults or novel observations (those classes not in the training data) in the test data. In another example, Grier et al., (10,222,315) describe the application of holographic microscopy techniques for characterizing protein aggregates. However, this application requires the precise calibration of various lasers applied to a biological sample and the concurrent measurement of their diffraction patterns. As a result, this system is less adaptable to various applications and must be precisely maintained diminishing its commercial effectiveness.

As can be seen from the above examples, there exists a need for a high-throughput, real-time system for monitoring and identifying foreign cells and rare mammalian cells within biological samples, and for monitoring and characterizing particulate contaminants within drug formulations. There also exists a need for a simple, economic and technically feasible system to detect protein aggregation as well as identify a priori known problematic or novel protein aggregates induced by unanticipated process upsets.

### SUMMARY OF THE INVENTION

One aspect of the current inventive technology includes systems and methods that may combine high-throughput flow imaging technology and machine learning, such as convolutional neural networks, in variety of relevant medical and pharmaceutical applications. In certain embodiments, the approaches described herein may use flow imaging microscopy (FIM) instrumentation and machine learning, such as Convolutional neural network (ConvNet) analysis, to analyze cells, pathogens, protein aggregates, and other target particles resolvable by a FIM, or other comparable instrument.

In one aspect of the current invention, the present inventors combined FIM with ConvNets to analyze particles, such as protein aggregates in drug products, genetically engineered bacteria cultures, and pathogens in blood among others. FIM is a light microscopy-based technique that utilizes microfluidics and light microscopy techniques to capture images of particles larger than approximately 200 nm in a sample. ConvNets are a family of neural networks capable of learning relevant properties of an input image that are useful when performing computer vision tasks such as object identification, classification, and statistical representation. Although the images obtained from the instrument contain a large amount of morphological information about the particles in a sample, it is difficult to manually extract this information from the raw images and to use that information to analyze the particles in a sample. In the present invention, it has been discovered that ConvNets can be trained using high-throughput FIM images, where each image is not provided a detailed class label, and the resulting network can be applied in order to extract and utilize the morphological information contained within the image.

In another aspect of the inventive technology, the present inventors utilize ConvNets to identify therapeutically relevant particles or cell characteristics among other applications. The present inventors have discovered that if these networks are trained on images obtained from flow imaging instruments, the networks are capable of learning complex features of the imaged particles that are difficult to extract by humans. The combination of these two techniques yields an effective tool for imaging and characterizing small (approximately 200 nm to 100 micron-sized) particles in liquid samples. Furthermore, since a variety of particles such as cells and large protein aggregates can be imaged using FIM instruments, this approach may be useful in a variety of medically- and pharmaceutically relevant applications.

As generally shown in FIG. 16, further aspects of the inventive technology includes systems and methods of applying machine learning to detect and analyze particles in liquid suspensions in high-throughput systems. In one preferred embodiment, a neural network, such as a multi-layer ConvNet, may be trained to generate an initial training dataset. In this embodiment, at least one reference dataset may be generated by passing a reference sample, which may preferably comprise particles in a liquid suspension, through a high-throughput flow imaging microscopy (FIM) instrument. Digital images of the particles passing through the FIM may be captured for later processing. These images may be transmitted to one or more processors, or other similar data processing device or system, where features of interest are extracted. This extraction may be accomplished in a preferred embodiment by a machine learning system, and more preferably a CovnNet Feature Extraction Module as generally described herein. In a preferred embodiment, at least 10⁴ to 10⁷ images of the individual components passing through said FIM instrument may be captured for further extraction and analysis.

In one optional embodiment, one or more additional reference datasets may be generated by the process generally described above. In this optional embodiment, one, or a plurality of additional samples comprising liquid suspensions of particles resulting from contaminants or process upsets may pass through a high-throughput FIM instrument. Digital images of the individual components of each sample may be captured and further processed to extract features of interest. In one embodiment, the extraction of features of interest may be accomplished by an Object of Interest Selection Module as detailed below.

Another aspect of the inventive technology includes methods and systems for generating a reference distribution by embedding the previously extracted features of interest from the reference sample. As detailed below, this embedding process may convert the extracted features of interest to a lower dimensional feature set which may be displayed and/or analyzed in a lower dimensional feature. In another optional embodiment, one or more additional samples identified above may be utilized to generate additional reference distributions through the novel process of embedding the extracted features of interest from the captured images of the additional samples so as to again, convert the extracted features of interest to a lower dimensional feature set. In this preferred embodiment, the embedding map(s) used to define the reference distributions of the reference, and optionally the additional samples, may be defined by using a loss function, as generally described herein, which may separate the embedded lower dimensional feature sets associated with each reference distribution. Further, the probability density of the individual extracted feature embeddings of the reference, and optionally the additional samples, may be estimated. In one preferred embodiment, the probability density of one or more of the additional samples on the embedding space may be further estimated.

In another aspect of the inventive technology, a test sample may be used to obtain a test dataset. In this embodiment, at least one test dataset may be generated by passing a test sample, which may preferably include particles in a liquid suspension, through a high-throughput flow imaging microscopy (FIM) instrument. Digital images of the particles from the test sample may be captured as those particles pass through a FIM or other like device. These images may be transmitted to one or more processors, or other similar data processing device or system, where one or more features of interest are extracted. This extraction may be accomplished in a preferred embodiment by a machine learning system, and more preferably a CovnNet Feature Extraction Module.

Another aspect of the invention may include the application of a Fault Detection Module, which may apply a fault detection algorithm to evaluate if a test distribution of embeddings from a test sample is consistent with a population density of features of interest by quantitatively comparing the statistical similarity of the test distribution of embeddings against the distribution of embeddings previously collected. In an optional embodiment, the inventive system may further include the step of evaluating if the test distribution of embeddings does not correspond to an a priori known population density distribution of embeddings. Additional optional embodiments may include the step of applying a Fusion Module incorporating features determined by other modalities to generate more additional features of interest or additional extracted feature embeddings.

Another aspect of the inventive technology includes the detection and analysis of a variety of sample types and particles. In one preferred embodiment, a sample, such as a reference sample, an additional sample, or test sample described above, may include biopharmaceutical formulations. In a preferred embodiment, such biopharmaceutical formulations may include particles in a liquid suspension, such as proteins, silicone oil microdroplets, glass microparticles or other particles and the like. In a preferred embodiment, a particle in a liquid suspension may include aggregated protein molecules, and more preferably aggregated protein molecules generated by a pharmaceutical fill-finish operation.

In even broader embodiments of the invention, a liquid sample or biopharmaceutical formulation may include biopharmaceutical formulations subject to one or more contaminants or process upsets selected from the group consisting of: a biopharmaceutical or liquid sample subjected to freeze-thawing, a biopharmaceutical or liquid sample subjected to shaking, a biopharmaceutical or liquid sample subjected to stirring, a biopharmaceutical or liquid sample subjected to elevated temperature, a biopharmaceutical or liquid sample subjected to cold stress, a biopharmaceutical or liquid sample subjected to chemical stress, a biopharmaceutical or liquid sample subjected to radiation, a biopharmaceutical or liquid sample subjected to pumping, a biopharmaceutical or liquid sample subjected to vibration, a biopharmaceutical or liquid sample subjected to or liquid mechanical shock, a biopharmaceutical or liquid sample subjected to contamination, and combinations thereof.

Naturally, such example particles are representative only, and not limiting on the number and variety of particles that may be used with the invention as described herein. For example, in some preferred embodiments, liquid suspensions of particles may include particles in drinking water, or even microcrystalline particles, for example in water used for industrial purposes, such as farming, or otherwise contaminated water.

Another aspect of the inventive technology may include methods of applying machine learning to detect and analyze characteristics of cell phenotypes in high-throughput systems. In this embodiment, at least one reference dataset may be generated by passing a reference sample, which may preferably comprise cells in a liquid suspension, through a high-throughput FIM instrument. In further preferred embodiments, a reference sample may comprise cells in a liquid culture having a consistent or homogenous phenotype, or cells in a liquid culture expressing a heterologous protein or nucleotide sequence, and more preferably at a known or quantified level. In alternative embodiments, additional reference cells may include: cells subjected to differential growth conditions, cells subjected to differential nutrient conditions, cells having lost some or all of a heterologous expression plasmid vector, cells having suppressed transcription of heterologous nucleotides; cells having suppressed translation of heterologous peptides; cells having suppressed transcription of endogenous nucleotides; cells having suppressed translation of endogenous peptides, cells having newly synthesized DNA, cells having newly synthesized RNA, cells expressing differential surface proteins, contaminating cells of a different cell type; and cells expressing differential biomarkers.

In this preferred embodiment, digital images of the cells passing through the FIM may be captured for later processing. These images may be transmitted to one or more processors, or other similar data processing device or system, where features of interest may be extracted. This extraction may be accomplished in a preferred embodiment by a machine learning system, and more preferably a CovnNet Feature Extraction Module. In a preferred embodiment, at least 10⁴ to 10⁷ images of the individual components passing through a FIM or similar instrument may be captured for extraction and analysis.

In one optional embodiment, one or more additional reference datasets may be generated by the process generally described above. In this optional embodiment, one, or a plurality of additional samples comprising liquid suspensions of cells that contain or are contaminated with cells of different phenotypes, or cells subjected to process upsets, or cells with different genotypes may pass through a high-throughput FIM or other similar instrument. Digital images of the individual components of each sample may be captured and further processed to extract features of interest. In one embodiment, the extraction of features of interest may be accomplished by an Object of Interest Selection module as detailed below.

Another aspect of the inventive methods and systems described herein may further include the step of generating a reference distribution by embedding the previously extracted features of interest from the reference sample. As detailed below, this embedding process may convert the extracted features of interest to a lower dimensional feature set. In another optional embodiment, one or more additional samples identified above may be utilized to generate additional reference distributions through the process of embedding the extracted features of interest from the images captured of the additional samples so as to again, convert the extracted features of interest to a lower dimensional feature set.

In this preferred embodiment, the reference distributions of the reference's embedding, and optionally the additional embeddings of additional samples, may be defined by using a loss function to separate the embedded lower dimensional feature sets associated with each reference distribution. Further, the probability density of the individual extracted feature embeddings of the reference and optionally the additional samples may be estimated, and in a preferred embodiment, the probability density of one or more of the additional samples on the embedding space may be further estimated.

In another aspect of the inventive technology, a test sample may be used to obtain a test dataset. In this embodiment, at least one test dataset may be generated by passing a test sample, for example a biological sample or other sample containing cells to be tested in a liquid suspension, through a high-throughput FIM or other similar instrument. Digital images of the cells from the test sample may be captured as those they pass through the high-throughput FIM. These images may be transmitted to one or more processors, or other similar data processing device or system, where features of interest are extracted. This extraction may be accomplished in a preferred embodiment by a machine learning system, and more preferably a CovnNet Feature Extraction Module.

Another aspect of the invention may include the application of a fault detection algorithm to evaluate if a test distribution of embeddings from a test sample, such as a biological sample, is consistent with a population density of features of interest by quantitatively comparing the statistical similarity of the test distribution of embeddings against the distribution of embeddings previously collected. In an optional embodiment, the inventive system may further include the step of evaluating if the test distribution of embeddings does not correspond to an a priori known population density distribution of embeddings. Additional optional embodiments may include the step of applying a fusion module incorporating features determined by other modalities to generate more additional features of interest or additional extracted feature embeddings.

Another aspect of the inventive technology may include methods of applying machine learning to detect and analyze cells and microbial pathogens in biological samples in high-throughput systems without labeling individual pathogens. In this embodiment, at least one reference dataset may be generated by passing a reference sample, which may preferably comprise cells in a biological sample, such as preferably a blood sample, or more preferably blood sample having a volume of 25 to 100 microliters, through a high-throughput FIM, or other similar instrument. Exemplary biological samples may include: sputum, oral fluid, amniotic fluid, blood, a blood fraction, bone marrow, a biopsy samples, urine, semen, stool, vaginal fluid, peritoneal fluid, pleural fluid, tissue explant, mucous, lymph fluid, organ culture, cell culture, or a fraction or derivative thereof or isolated therefrom.

Digital images of the individual components of the biological sample passing through the FIM may be captured for later processing. These images may be transmitted to one or more processors, or other similar data processing device or system, where features of interest are extracted. In one preferred embodiment, an extracted feature of interest is correlated with a known disease condition, such as sepsis. In alternative embodiments, a disease condition may be associated with the type or quantity of the extracted feature of interest or the type and quantity of cells found in the biological sample. This extraction may be accomplished, in a preferred embodiment, by a machine learning system, and more preferably a CovnNet Feature Extraction Module. In another preferred embodiment, at least 10⁴ to 10⁷ images of the individual components passing through said FIM instrument may be captured for further extraction and analysis.

In one optional embodiment, one or more additional reference datasets may be generated by the process generally described above. In this optional embodiment, one, or a plurality of additional samples comprising liquid suspensions of cells resulting from infection, or contamination, or a disease state may pass through, for example, a high-throughput FIM instrument. Digital images of the individual components of each sample may be captured and further processed to extract features of interest. In one embodiment, the extraction of features of interest may be accomplished by an Object of Interest Selection Module as detailed below.

Another aspect of the inventive methods and systems described herein may further include the step of generating a reference distribution by embedding the previously extracted features of interest from the reference sample, in this case a reference biological sample. As detailed below, this embedding process may convert the extracted features of interest to a lower dimensional feature set. In another optional embodiment, one or more additional samples identified above may be utilized to generate additional reference distributions through the process of embedding the extracted features of interest from the images capture of the additional samples so as to again, convert the extracted features of interest to a lower dimensional feature set. In this preferred embodiment, the reference distributions of the reference's embedding, and optionally the additional embeddings of additional samples, may be defined by using a loss function to separate the embedded lower dimensional feature sets associated with each reference distribution. Further, the probability density of the individual extracted feature embeddings of the reference and optionally the additional samples may be estimated, and in a preferred embodiment, the probability density of one or more of the additional samples on the embedding space may be further estimated. Additional optional embodiments may include the step of applying a fusion module incorporating features determined by other modalities to generate more additional features of interest or additional extracted feature embeddings.

Other features, objects, and advantages of the invention will be apparent from the Detailed Description, the Figures, the Examples, and the Claims.

This Summary is neither intended nor should it be construed as being representative of the full extent and scope of the present disclosure. Moreover, references made herein to “the present disclosure,” or aspects thereof, should be understood to mean certain embodiments of the present disclosure and should not necessarily be construed as limiting all embodiments to a particular description. The present disclosure is set forth in various levels of detail in this Summary as well as in the attached drawings and the Description of Embodiments and no limitation as to the scope of the present disclosure is intended by either the inclusion or non-inclusion of elements, components, etc. in this Summary. Additional aspects of the present disclosure will become more readily apparent from the Description of Embodiments, particularly when taken together with the drawings. The present application further refers to various journal articles, and other publications, all of which are incorporated herein by reference. The details of one or more embodiments of the invention are set forth herein.

### BRIEF DESCRIPTION OF FIGURES

The above and other aspects, features, and advantages of the present disclosure will be better understood from the following detailed descriptions taken in conjunction with the accompanying figures, all of which are given by way of illustration only, and are not limiting the presently disclosed embodiments, in which:

FIG. 1: Shows a general schematic of a method of analyzing imaging data from flow microscopy and assessing the captured images to detect, diagnose, and monitor target biomolecules in one embodiment thereof.

FIG. 2: Shows a confusion matrix for a ConvNet designed to distinguish between small blood particles and different species of bacteria. The rows of this matrix correspond to images containing specific cell types while the columns correspond to the output of the ConvNet. Each entry of the matrix can be interpreted as the probability that a single random image of a cell type (matrix row) is identified as a particular cell type by the algorithm (matrix columns). This matrix indicates that roughly 99% of both small blood cells and bacteria are correctly identified by the trained ConvNet.

FIG. 3: Shows a confusion matrix used by a ConvNet in the “Classification Module” (see FIG. 1. workflow) to quantify the accuracy possible when attempting to identify several organisms in an exemplary neonatal sepsis cases.

FIG. 4: Shows sample FIM pictures of a mixture of E. coli in simulated urine solution.

FIG. 5: Shows sample FIM pictures of E. coli strains that produce HGH (top) and HPV capsid protein (bottom).

FIG. 6: Shows a confusion matrix for a ConvNet trained on strains of E. coli expressing different recombinant proteins.

FIG. 7: Shows sample FIM images of protein aggregates generated via four mechanisms used to train and test a ConvNet for fault detection.

FIG. 8: Shows fault detection using ConvNets on grayscale FIM images. After training, we applied the trained network to synthetic datasets containing the fraction of particles generated via a stirring stress upset shown in the top panel and the rest particles generated by a fill-finish process. The bottom panel shows the deviation from the normal process conditions returned by the network. The network correctly identifies datasets that only contain particles made by the process (batches 1-100) as normal and datasets with increasing fractions of stirring particles as increasingly deviant from the normal process.

FIG. 9: Demonstration of nonlinear ConvNet embeddings obtained from color FIM images of monoclonal and polyclonal protein aggregates formed from known stress conditions. This figure provides a qualitative demonstration of the ability to detect faults; a quantitative demonstration of the ability to detect departures from reference case shown in FIG. 12.

FIG. 10: Demonstration of ability to detect large a priori unknown process upset induced by new process pump. This figure provides a qualitative demonstration of the ability to detect faults; a quantitative demonstration of the ability to detect departures from reference case shown in FIG. 12.

FIG. 11A-B: Demonstration of ability to detect subtle unanticipated process upset induced by ethanol washing of vials containing protein therapeutic solution. This figure provides a qualitative demonstration of the ability to detect faults; a quantitative demonstration of the ability to detect departures from reference case shown in FIG. 12.

FIG. 12: Demonstration of quantitative ability to detect a fault and process upset. Table shown summarizes hypothesis testing results (conducted with a target 5% false alarm rate) for reference case and various stresses. Reported rejection rates are average rejection rate over 10,000 draws of size N (two values summarized herein) using a target false alarm rate, a, or 5%.

FIG. 13: Show a schematic flowchart for an exemplary sepsis detection algorithm in one embodiment thereof.

FIG. 14A-G: Sample images taken with a FlowCam Nano instrument of (A1-2) blood, (B) A. baumannii, (C) E. coli, (D) E. faecalis, (E) K. pneumoniae, (F) P. aeruginosa, and (G) S. aureus.

FIG. 15: Sample images of blood taken with a FlowCam Nano instrument after applying a 5 μm size threshold. (A) Images of particles larger than 5 μm (B) images of particles smaller than 5 μm.

FIG. 16: Shows a general flowchart of a method of applying machine learning to detect and analyze one or more features of interest in in a sample in high-throughput systems in one embodiment thereof.

### DETAILED DESCRIPTION OF THE INVENTION

The embodiments herein and the various features and details thereof are explained more fully with reference to the non-limiting embodiments that are illustrated in the accompanying drawings and detailed in the following description. Descriptions of well-known components and processing techniques are omitted to avoid unnecessarily obscuring the embodiments herein. Also, the various embodiments described herein are not necessarily mutually exclusive, as some embodiments can be combined with one or more other embodiments to form new embodiments. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

This disclosure provides automated biological sample test systems for rapid analysis of target particles, such as biomolecules, such as cells and pathogens in biological or biopharmaceutical samples processed through high-throughput cytometry or other similar separation or analysis methods. In preferred embodiments, these systems may rapidly and efficiently identify the presence of target particles, such as cells and biomolecules in a sample, and may further be used to analyze high volumes of biological samples without the need of human intervention.

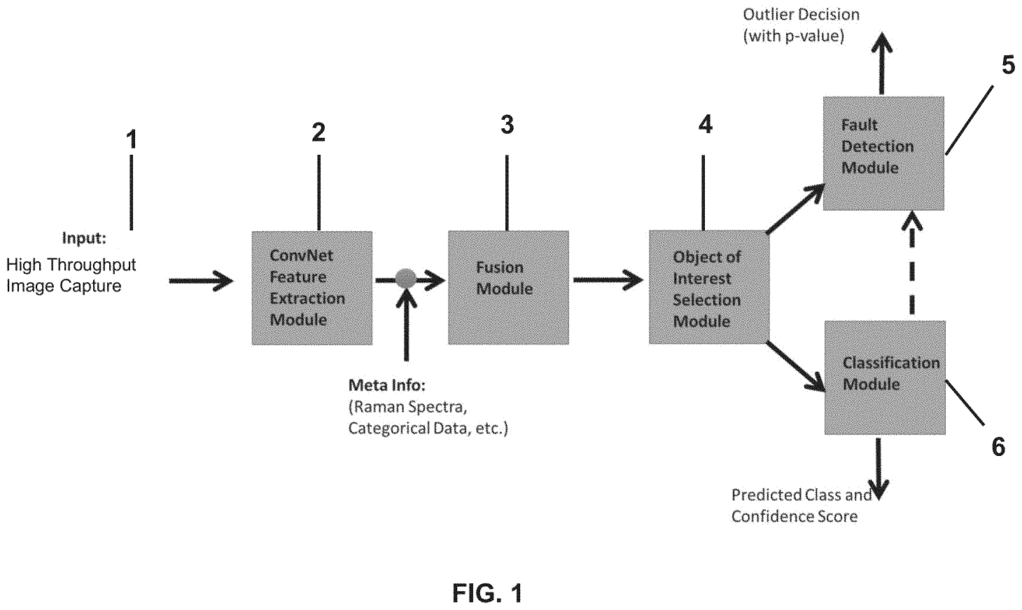

The disclosed invention extends and modifies state-of-the-art technology in experimental high-throughput flow imaging microscopy, flow cytometry, machine learning, and computational statistics. The invention enables the ability to classify experimental images into pre-defined classes and/or label the observation as an a priori known or a priori unknown “fault” meaning that the observation is statistically unlikely to have come from a measured reference population of responses. As generally shown in FIG. 1, the invention may include a multi-component system to capture high-throughput flow imaging microscopy and apply machine learning applications to such images and thereby achieve a classification of subject particles, cell, biomolecule or other target. Each of the modules in the diagram can be accomplished by a variety of methods and components. Exemplary preferred embodiments of each component in the schematic of FIG. 1 are described in the Examples section.

In one preferred embodiment, the present inventors expand on the type input and output of each module using terminology known by a person having ordinary or skill in the art. Notable, is that in the preferred embodiment demonstrated in FIG. 1, all of the parameters required to specify the function evaluations in the various modules may be assumed to have already been estimated using a large collection of labeled raw or processed image data (where “processed” implies that the modules upstream have produced the correct input) by minimizing a suitable “cost function”, where the cost function can aim at classification (e.g. a “cross entropy loss” function) as would be needed, for example, in pathogen analysis or the cost function can aim at developing a low dimensional representation through “image embeddings” for applications in fault detection (e.g. using a triplet loss or function or least squares type loss).

As shown in FIG. 1, a plurality of microscopy images (1) may be taken and inputted into the inventive system for further analysis. In one preferred embodiment, a plurality of images may be captured of the individual components of a sample, such as a biological or biopharmaceutical sample, subjected to high-throughput flow cytometry or other similar processes. This high-throughput imaging may be further analyzed to detect, diagnose, and monitor harmful foreign infectious biomolecules, such as bacterium in mammals, or biopharmaceuticals for example as part of quality control for injectable protein therapeutics and the like. In a preferred embodiment, microscopy images may be from a bright field or fluorescence microscope or other similar imaging device such as Flow-Imaging Microscopy (FIM). As will be discussed below, in preferred embodiments, a plurality of microscopy images may be used to generate training datasets. While the number of images required for such high-throughput training sets may depend on the application and feature of interest among other considerations, in one embodiment, such high-throughput training sets may range from at least 10³ to 10⁶ images, or more preferably 10⁴ to 10⁷ or more images.

As shown in FIG. 1, in one preferred embodiment a “ConvNet Feature Extraction Module” (2) may take a collection of raw or preprocessed (where the preprocessing step may cull images based on estimated size of objects in the image above or below a given size threshold) images measured from a high-throughput microscopy device as input and extracts “features,” generally referred to as a “features of interest.” These features may typically be extracted via Convolutional Neural Networks (CNNs), but could be extracted by other feature extractors, such as Principal Component Analysis (PCA). The outputs of this module may be the resulting features and optionally the original image measurement for further processing downstream.

Again, referring generally to FIG. 1, in one preferred embodiment, a “Fusion Module” (3) may be optional used to leverage data and/or meta-information from other sources. The features from a ConvNet may be combined with other measurement or descriptive features through a variety of methods (e.g. a two input Artificial Neural Network, a Random Forest algorithm or Gradient Boosting algorithm for feature selection) producing a new set of feature of interest outputs or image embeddings; if there is no additional information to leverage or it is desired not to alter the features at this stage, this module can serve as an “identity” function producing output identical to all or a subset of the input to this module.

As also shown in FIG. 1, an “Object of Interest Selection Module” (4) may decide which measurements features and/or images may be further processed downstream and which will be ignored. For example, in a pathogen analysis embodiment, blood platelets may be ignored in downstream analysis and in protein fault detection. In this embodiment silicone oil or air bubbles passing through a FIM instrument could also be ignored. This module can use another Artificial Neural Network (ANN) to produce a new set of features or embeddings (depending on the specific application) or can be a standard high-dimensional classifier acting on the input and serving as a “gate function.” In alternative embodiments, this step can also be an “identity” function passing all or a subset of features through to the next step unaltered. The branch taken in the next step may be application dependent. One branch, which for example may be used in a pathogen identification embodiment, may include a “Classification Module” (6) that assigns a predefined label and probability of a class based on the passed in features/images using another classifier. The subsequent class and class probability output can either be the final output, or the features/raw input features can be embedded via another pretrained ANN and passed to the other branch, in this instances the “Fault Detection Module” (5). The “Fault Detection Module” may take low-dimensional embedding representations of the raw images and runs statistical hypothesis tests to check if it is statistically probable that the collection of embeddings has been drawn from a precomputed reference distribution of interest. This step may incorporate a precomputed empirically determined probability distribution (where the distribution function estimation can be parametric or nonparametric) of a suitable goodness-of-fit test statistic characterizing a large collection of labeled ground truth data. The aforementioned distribution may then be used to compute a p-value for each image in the “test dataset” enabling a user to detect if the test statistic generated by the collection of embeddings of the unlabeled data are statistically similar to the embeddings of the labeled reference distribution.

As further shown in FIG. 1, the dashed arrow is used to show that the output of the “Classification Module” can be used to verify the diagnosis for the candidate predicted class label which may be useful in applications where a priori unanticipated contaminants of similar size to the objects of interest can be in the sample since the classification algorithm used in this stage is assumed to be trained on a fixed known list of candidate class labels.

Unless otherwise indicated, the method operations and device features disclosed herein involve techniques and apparatus used in microbiology, geometric optics, software design and programming, and statistics, which are within the skill of the art.

Unless defined otherwise herein, all technical and scientific terms used herein have the same meaning as commonly understood by one of ordinary skill in the art. Although any methods and materials similar or equivalent to those described herein find use in the practice or testing of the embodiments disclosed herein, some methods and materials are described in detail and represent preferred embodiments of the current inventive technology.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both, which specifically includes cloud-based applications. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors or through a cloud-based application.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The headings provided herein are not intended to limit the disclosure.

As used herein, the singular terms “a,” “an,” and “the” include the plural reference unless the context clearly indicates otherwise. The term “or” as used herein, refers to a non-exclusive or, unless otherwise indicated.

The terms defined immediately below are more fully described by reference to the specification as a whole. It is to be understood that this disclosure is not limited to the particular methodology, protocols, and reagents described, as these may vary, depending upon the context in which they are used by those of skill in the art.

The term “plurality” refers to more than one element. For example, the term is used herein in reference to more than one type of parasite or pathogen in a biological sample; more than one sample feature (e.g., a cell) in an image of a biological sample; more than one layer in a deep learning model; and the like.

The terms “threshold” herein refer to any number that is used as, e.g., a cutoff to classify a sample feature as particular type of parasite or pathogen, or a ratio of abnormal to normal cells (or a density of abnormal cells) to diagnose a condition related to abnormal cells, or the like. The threshold may be compared to a measured or calculated value to determine whether the source giving rise to such value suggests that it should be classified in a particular manner. Threshold values can be identified empirically or analytically. The choice of a threshold is dependent on the level of confidence that the user wishes to have to make the classification. Sometimes they are chosen for a particular purpose (e.g., to balance sensitivity and selectivity).

The term “biological sample,” “biopharmaceutical sample,” or “sample” refers to a sample to be analyzed with the invention as generally described herein. In addition, as generally used herein a “biological sample” or “sample” may include any sample that may be subject to a high-throughput process, such as high throughput flow imaging microscopy. In one preferred embodiment, a “biological sample” or “sample” may include a pharmaceutical preparation, such as a protein-based therapeutic that may be subject to a high-throughput process, such as high throughput flowimaging microscopy. A “reference sample” as used herein is a sample that may be used to train a computer learning systems, such as by generating a training dataset. A “test sample” as used herein is a sample that may be used to generate a test dataset, for example of one or more features of interest, which may be qualitatively and/or quantitatively compared to a training dataset as generally described herein.

In preferred embodiments, a “biological sample” or “sample” refers to a sample typically derived from a biological fluid, tissue, organ, etc., often taken from an organism suspected of having a condition, such as a disease or disorder, such as an infection. Such samples include, but are not limited to sputum/oral fluid, amniotic fluid, blood, a blood fraction, bone marrow, fine needle biopsy samples (e.g., surgical biopsy, fine needle biopsy, etc.), urine, semen, stool, vaginal fluid, peritoneal fluid, pleural fluid, tissue explant, organ culture, cell culture, and any other tissue or cell preparation, or fraction or derivative thereof or isolated therefrom.

A biological sample may be taken from a multicellular organism or it may be of one or more single cellular organisms. In some cases, the biological sample is taken from a multicellular organism, such as a mammal, and includes both cells comprising the genome of the organism and cells from another organism such as a parasite or pathogen. The sample may be used directly as obtained from the biological source or following a pretreatment to modify the character of the sample. For example, such pretreatment may include preparing plasma from blood, diluting viscous fluids, culturing cells or tissue, and so forth. Methods of pretreatment may also involve, but are not limited to, filtration, precipitation, dilution, distillation, mixing, centrifugation, freezing, lyophilization, concentration, amplification, nucleic acid fragmentation, inactivation of interfering components, the addition of reagents, lysing, etc. Such “treated” or “processed” samples are still considered to be biological samples with respect to the methods described herein.

Biological samples can be obtained from any subject or biological source. Although the sample is often taken from a human subject (e.g., a patient), samples can be taken from any organism, including, but not limited to mammals (e.g., dogs, cats, horses, goats, sheep, cattle, pigs, etc.), non-mammal higher organisms (e.g., reptiles, amphibians), vertebrates and invertebrates, and may also be or include any single-celled organism such as a eukaryotic organism (including plants and algae) or a prokaryotic organism, archaeon, microorganisms (e.g. bacteria, archaea, fungi, protists, viruses), and aquatic plankton.

In various embodiments described herein, a biological sample is taken from an individual or “host.” Such samples may include any of the cells of the host (i.e., cells having the genome of the individual) or host tissue along with, in some cases, any non-host cells, non-host multicellular organisms, etc. described below. In various embodiments, the biological sample is provided in a format that facilitates imaging and automated image analysis. As an example, the biological sample may be stained before image analysis.

As used herein, a host is an organism providing the biological sample. Examples include higher animals including mammals, including humans, reptiles, amphibians, and other sources of biological samples as presented above.

As used herein, a “feature,” “feature of interest” or “sample feature” is a feature of a sample that represents a quantifiable and/or observable feature of an object or particle passing through a high-throughput system. In certain embodiments, a “feature of interest” may potentially correlate to a clinically relevant condition. In certain embodiments, a feature of interest is a feature that appears in an image of a sample, such as a biological sample, and may be recognized, segmented, and/or classified by a machine learning model. Examples of features of interest include components of images of a biological sample; the aforementioned images can characterize objects such as cells of the host (including both normal and abnormal host cells; e.g., tumor and normal somatic cells) red blood cells (nucleated and anucleated), white blood cells, somatic non-blood cells, and the like, biomolecules, such as protein aggregates, cell expressing one or more heterologous nucleotides, and generally any observable particle, for example suspended in a liquid solution that may be passed through a high-throughput flow imagining system. Each of these examples of a feature of interest presented above can be used as a separate classification for the machine learning systems described herein. Such systems can classify any of these alone or in combination with other examples. Types of white blood cells include neutrophils, lymphocytes, basophils, monocytes, and eosinophils. Parasitical or pathogenic organisms present in the host may include both obligate parasites, which are completely dependent on host to complete their life cycles, and facultative parasites, which can be operational outside the host. In some cases, the classifiers described herein classify only parasites that are endoparasites; i.e., parasites that live inside their hosts rather than on the skin or outgrowths of the skin. Types of endoparasites that can be classified by methods and apparatus described herein include intercellular parasites (inhabiting spaces in the host's body, including the blood plasma) and intercellular parasites (inhabiting spaces in the host's body, including the blood plasma). An example of an intercellular parasite is Babesia, a protozoan parasite that can produce malaria-like symptoms. Examples of intracellular parasites include protozoa (eukaryotes), bacteria (prokaryotes), and viruses. Protozoa may be worms; examples of obligate protozoa include: Apicomplexans (Plasmodium spp. including Plasmodium falciparum (malarial parasite) and Plasmodium vivax), Toxoplasma gondii and Cryptosporidium parvum) (toxoplasmosis parasite), Trypanosomatids (Leishmania spp. and Trypanosoma cruzi) (chagas parasite), Cytauxzoon, Schistosoma. Bacterial examples include: (i) Facultative examples: Bartonella henselae Francisella tularensis, Listeria monocytogenes, Salmonella typhi, Brucella, Legionella, Mycobacterium, Nocardia, Rhodococcus equi, Yersinia, Neisseria meningitidis, Filariasis, Mycoplasma; and (ii) Obligate examples: Chlamydia, and closely related species. Rickettsia, Coxiella, Certain species of Mycobacterium such as Mycobacterium leprae, Anaplasma phagocytophilum. Examples of Fungi include: (i) Facultative examples: Histoplasma capsulatum, Cryptococcus neoformans, Yeast/saccharomyces; and (ii) Obligate examples: Pneumocystis jirovecii. Viruses are typically obligate and some are large enough to be identified by the resolution of the imaging systems of this disclosure. Helminths: Flatworms (platyhelminths)—these include the trematodes (flukes) and cestodes (tapeworms), thorny-headed worms (acanthocephalins)—the adult forms of these worms reside in the gastrointestinal tract, roundworms (nematodes)—the adult forms of these worms can reside in the gastrointestinal tract, blood, lymphatic system or subcutaneous tissues.

Additional classifications are possible based on morphological differences that are detectable using image analysis systems described herein. For example, the protozoa that are infectious to humans can be classified into four groups based on their mode of movement: Sarcodina—the ameba, e.g., Entamoeba; Mastigophora—the flagellates, e.g., Giardia, Leishmania; Ciliophora—the ciliates, e.g., Balantidium; Sporozoa—organisms whose adult stage is not motile e.g., Plasmodium, Cryptosporidium.

As used herein, a machine learning system or model is a trained computational model that takes a feature of interest, such as cellular artifacts extracted from an image and classifies them as, for example, particular cell types, parasites, bacteria, protein aggregates etc. Cellular artifacts that cannot be classified by the machine learning model are deemed peripheral or unidentifiable objects. Examples of machine learning models include neural networks, including recurrent neural networks and convolutional neural networks; random forests models, including random forests; restricted Boltzmann machines; recurrent tensor networks; and gradient boosted trees. The term “classifier” (or classification model) is sometimes used to describe all forms of classification model including deep learning models (e.g., neural networks having many layers) as well as random forests models.

As used herein, a machine learning system may include a deep learning model that may include a function approximation method aiming to develop custom dictionaries configured to achieve a given task, be it classification or dimension reduction. It may be implemented in various forms such as by a neural network (e.g., a convolutional neural network), etc. In general, though not necessarily, it includes multiple layers. Each such layer includes multiple processing nodes and the layers process in sequence, with nodes of layers closer to the model input layer processing before nodes of layers closer to the model output. In various embodiments, one-layer feeds to the next, etc. The output layer may include nodes that represent various classifications. In some embodiments, a deep learning model is a model that takes data with very little preprocessing, although it may be segmented data such as cellular artifact, or other features of interest may be extracted from an image, and outputs a classification of the cellular artifact.

In various embodiments, a deep learning model may have significant depth and can classify a large or heterogeneous array of features of interest, such as protein aggregates, particles in a liquid suspension, or cellular artifacts, such as pathogens or gene expression. In some contexts, the term “deep” means that model has a plurality of layers of processing nodes that receive values from preceding layers (or as direct inputs) and that output values to succeeding layers (or the final output). Interior nodes are often “hidden” in the sense that their input and output values are not visible outside the model. In various embodiments, the operation of the hidden nodes may not be monitored or recorded during operation. The nodes and connections of a deep learning model can be trained, for example with a “reference” or “additional sample,” and retrained without redesigning their number, arrangement, interface with image inputs, etc. and yet classify a large heterogeneous range of features of interest, such as cells, target biomolecules, cells expressing one or more genes, or particles in a liquid suspension and the like.

In various aspects, provided herein are systems and methods for identifying and optionally characterizing a feature of interest, by analyzing the feature of interest from a test sample and thereby generating a test dataset and comparing it to a training dataset generated from a reference sample, and optionally one or more additional samples. A feature of interest in this embodiment may include a feature of the cell, such as cell morphology, as well as the presence, absence, or relative amount of one or more biomarkers within and/or associated with the cell, protein aggregates generated in a finish and fill pharmaceutical system, as well as characteristics of various particles in a liquid suspension.

For example, in one specific embodiment, provided herein are systems and methods for identifying and optionally characterizing a cell of interest as a target cell by analyzing a signature of the cell of interest, quantified by a “feature of interest” extracted from the image via a ConvNet, in a test sample and comparing it to a signature of the target cell from a reference sample. A signature of a cell, or “feature of interest” may also include a physical feature of the cell, such as cell morphology, as well as the presence, absence, or relative amount of gene expression within and/or associated with the cell.

A “feature of interest” of a cell of interest may be useful for diagnosing or otherwise characterizing a disease or a condition in a patient from which the potential target cell was isolated. As used herein, an “isolated cell” refers to a cell separated from other material in a biological sample using any separation method. An isolated cell may be present in an enriched fraction from the biological sample, and thus its use is not meant to be limited to a purified cell. In some embodiments, the morphology of an isolated cell is analyzed. For target cells indicative of infection, analysis of a cell signature is useful for a number of methods including diagnosing infection, determining the extent of infection, determining a type of infection, and monitoring progression of infection within a host or within a given treatment of the infection. Some of these methods may involve monitoring a change in the signature of the target cell, which includes an increase and/or decrease, and/or any change in morphology.

In some embodiments, a “feature of interest” of a cell of interest is analyzed in a fraction of a biological sample of a subject, wherein the biological sample has been processed to enrich for a target cell. In some cases, the enriched fraction lacks the target cell and the absence of a signature of a target cell in the enriched fraction indicates this absence. Target cells include blood cells, such as lymphoid cells, such as Natural killer cells, T lymphocytes, B lymphocytes, and other lymphoid cells.

In some embodiments, a “Population Distribution” refers to an aggregate collection of features of interest associated with a reference or other sample as generally described herein. The “Population Distribution” corresponds to the unknowable cumulative distribution function characterizing a population. This quantity is estimated via the probability density function in some embodiments.

As used herein, “Target Cell Populations” refers to the identified target cells in aggregate form. These populations can be thought of as point clouds that display characteristic shapes and have aggregate locations in a multidimensional space. In the multidimensional space, an axis is defined by a flow measurement channel, which is a source of signal measurements in flow cytometry. Signals measured, for example, in flow cytometry may include, but are not limited to, optical signals and measurements. Exemplary channels of optical signals include, but are not limited to, one or more of forward scatter channels, side scatter channels, and laser fluorescence channels.

All flow cytometry instrument channels or a subset of the channels may be used for the axes in the multidimensional space. A population of cells may be considered to have changed in the multidimensional channel space when the channel values of its individual cell members change and in particular when a large number of the cells in the population have changed channel values. For example, the point cloud representing a population of cells can be seen to vary in location on a 2-dimensional (2D) dot plot or intensity plot when samples are taken from the same individual at different times. Similarly, the point cloud representing a population of cells can shift, translate, rotate, or otherwise change shape in multidimensional space. Whereas conventional gating provides total cell count within a gate region, the location and other spatial parameters of certain cell population point clouds in multidimensional space, in addition to providing total cell count, provide additional information which can also be used distinguish between normal subjects (e.g., subjects without an infection) and infected patients (e.g., subjects with a parasite or pathogen infection).

Provided herein are systems and methods for identifying and optionally characterizing a cell, cells of interest as a target cell by analyzing a signature of the cell of interest. In some instances, a cell of interest is a parasitic or pathogenic cell. Flow cytometry may be used to measure a signature of a cell such as the presence, absence, or relative amount of the cell, or through differentiating physical or functional characteristics of the target cells of interest. Cells of interest identified using the systems and methods as described herein include cell types implicated in a disease, disorder, or a non-disease state. Exemplary types of cells include, but are not limited to, parasitic or pathogenic cells, infecting cells, such as bacteria, viruses, fungi, helminths, and protozoans. Cells of interest in some cases are identified by at least one of alterations in cell morphology, cell volume, cell size and shape, amounts of cellular components such as total DNA, newly synthesized DNA, gene expression as the amount messenger RNA for a particular gene, amounts of specific surface receptors, amounts of intracellular proteins, signaling events, or binding events in cells. In some cases, cells of interest are identified by the presence or absence of biomarkers such as proteins, lipids, carbohydrates, and small metabolites.

In some instances, cells are acquired from a subject by a blood draw, a marrow draw, or a tissue extraction. Often, cells are acquired from peripheral blood of a subject. Sometimes, a blood sample is centrifuged using a density centrifugation to obtain mononuclear cells, erythrocytes, and granulocytes. In some instances, the peripheral blood sample is treated with an anticoagulant. In some cases, the peripheral blood sample is collected in, or transferred into, an anticoagulant-containing container. Non-limiting examples of anticoagulants include heparin, sodium heparin, potassium oxalate, EDTA, and sodium citrate. Sometimes a peripheral blood sample is treated with a red blood cell lysis agent.

Alternately or in combination, cells are acquired by a variety of other techniques and include sources such as bone marrow, ascites, washes, and the like. In some cases, tissue is taken from a subject using a surgical procedure. Tissue may be fixed or unfixed, fresh or frozen, whole or disaggregated. For example, disaggregation of tissue occurs either mechanically or enzymatically. In some instances, cells are cultured. The cultured cells may be developed cell lines or patient-derived cell lines. Procedures for cell culture are commonly known in the art.

Systems and methods as described herein can involve analysis of one or more test samples from a subject compared against one or more reference samples/datasets. A sample may be any suitable type that allows for the analysis of different discrete populations of cells. A sample may be any suitable type that allows for analysis of a single cell population. Samples may be obtained once or multiple times from a subject. Multiple samples may be obtained from different locations in the individual (e.g., blood samples, bone marrow samples, and/or tissue samples), at different times from the individual (e.g., a series of samples taken to diagnose a disease or to monitor for return of a pathological condition), or any combination thereof. These and other possible sampling combinations based on sample type, location, and time of sampling allow for the detection of the presence of cells before and/or after infection and monitoring for disease.

When samples are obtained as a series, e.g., a series of blood samples obtained after treatment, the samples may be obtained at fixed intervals, at intervals determined by status of a most recent sample or samples, by other characteristics of the individual, or some combination thereof. For example, samples may be obtained at intervals of approximately 1, 2, 3, or 4 days, at intervals of approximately 1, 2, 3, 4, 5, 6, 7, 8, 9, 10, or 11 hours, at intervals of approximately 1, 2, 3, 4, 5, or more than 5 months, or some combination thereof.

To prepare cells for analysis using the methods and systems described herein, cells can be prepared in a single-cell suspension. For adherent cells, both mechanical or enzymatic digestion and an appropriate buffer can be used to remove cells from a surface to which they are adhered. Cells and buffer can then be pooled into a sample collection tube. For cells grown in suspension, cells and medium can be pooled into a sample collection tube. Adherent and suspension cells can be washed by centrifugation in a suitable buffer. The cell pellet can be re-suspended in an appropriate volume of suitable buffer and passed through a cell strainer to ensure a suspension of single cells in suitable buffer. The sample can then be vortexed prior to performing a method using the flow cytometry system on the prepared sample.

Once cell samples have been collected, they may be processed and stored for later usage, processed and used immediately, or simply used immediately. In some cases, processing includes various methods of treatment, isolation, purification, filtration, or concentration. In some instances, fresh or cryopreserved samples of blood, bone marrow, peripheral blood, tissue, or cell cultures are used for flow cytometry.

When samples are stored for later usage, they may be stabilized by collecting the sample in a cell preparation tube and centrifuging the tube after collection.

In some instances, the number of cells that are measured by flow cytometry is about 1,000 cells, about 5,000 cells, about 10,000 cells, about 40,000 cells, about 100,000 cells, about 500,000 cells, about 1,000,000 cells, or more than 1,000,000 cells. In some instances, the number of cells that are measured by flow cytometry is up to about 1,000 cells, up to about 5,000 cells, up to about 10,000 cells, up to about 40,000 cells, up to about 100,000 cells, up to about 500,000 cells, up to about 1,000,000 cells, up to about 1,000,000 cells, up to about 10,000,000 cells, up to about 100,000,000 cells, up to about 1,000,000,000 cells, up to about 10,000,000,000 cells, up to about 100,000,000,000 cells, up to about 1,000,000,000,000 cells, or more than 1,000,000,000,000 cells.

In general, flow cytometry involves the passage of individual cells through the path of one or more laser beams. Flow cytometry may measure at least one of cell size, cell volume, cell morphology, cell granularity, the amounts of cell components such as total DNA, newly synthesized DNA, gene expression as the amount messenger RNA for a particular gene, amounts of specific surface receptors, amounts of intracellular proteins, or signaling or binding events in cells. In some instances, cell analysis by flow cytometry on the basis of granularity or cell size may be combined with a determination of other flow cytometry readable outputs, such as to provide a correlation between the activation level of a multiplicity of elements and other cell qualities measurable by flow cytometry for single cells.

In some instances, flow cytometry data is presented as a single parameter histogram. Alternatively, or additionally, flow cytometry data is presented as 2-dimensional (2D) plots of parameters called cytograms. Often in cytograms, two measurement parameters are depicted such as one on an x-axis and one on a y-axis. In some instances, parameters depicted comprise at least one of side scatter signals (SSCs), forward scatter signals (FSCs), and fluorescence. In some instances, data in a cytogram is displayed as at least one of a dot plot, a pseudo-color dot plot, a contour plot, or a density plot. For example, data regarding cells of interest is determined by a position of the cells of interest in a contour or density plot. The contour or density plot can represent a number of cells that share a characteristic such as expression of particular biomarkers, or cell morphology or granularity.

Flow cytometry data is conventionally analyzed by gating. Often sub-populations of cells are gated or demarcated within a plot. Gating can be performed manually or automatically. Manual gates, by way of non-limiting example, can take the form of polygons, squares, or dividing a cytogram into quadrants or other sectional measurements. In some instances, an operator can create or manually adjust the demarcations to generate new sub-populations of cells. Alternately or in combination, gating is performed automatically. Gating can be performed, in some part, manually or in some part automatically.

In some instances, gating is performed using a computing platform. A computing platform may be equipped with user input and output features that allow for gating of cells of interest. A computing platform typically comprises known components such as a processor, an operating system, system memory, memory storage devices, input-output controllers, input-output devices, and display devices. In some instances, a computing platform comprises a non-transitory computer-readable medium having instructions or computer code thereon for performing various computer-implemented operations.

Gating, in some instances, involves using scatter signals, for example forward scatter (FSC), to differentiate subcellular debris from cells of interest. In some instances, single cells are gated from multiple or clumps of cells. In some instances, cells in a sample can be individually gated from an analysis based on the viability of the cell. For example, gating is used to select out live cells and exclude the dead or dying cells in the population by cell staining. Exemplary stains are 4′,6-diamidino-2-phenylindole (DAPI) or Hoescht stains (for example, Hoescht 33342 or 33258). In some instances, gating is applied to at least one physical characteristic or marker to identify cells of interest, such as infecting pathogen or parasitic cells.

In some instances, comparing changes in a set of flow cytometry samples is done by overlaying histograms of one parameter on a same plot. For example, arrayed flow cytometry experiments contain a reference sample against which experimental samples are compared. This reference sample can then be placed in the first position of an array, and subsequent experimental samples follow a control in a sequence. Reference samples can include normal and/or cells associated with a condition (e.g. infected cells).

In some cases, prior to analyzing data, the cell populations of interest and the method for characterizing these populations are determined. For example, cell populations are homogenous or lineage gated in such a way as to create distinct sets considered to be homogenous for targets of interest. An example of sample-level comparison would be the identification of biomarker profiles in infected cells of a subject and correlation of these profiles with biomarker profiles in non-infected cells. In some instances, individual cells in a heterogeneous population are mapped.

Alternately or in combination with flow cytometry, cells of interest may be identified by other spectrophotometric means, including but not limited to mass cytometry, cytospin, or immunofluorescence. Immunofluorescence can be used to identify cell phenotypes by using an antibody that recognizes an antigen associated with a cell. Visualizing an antibody-antigen interaction can be accomplished in a number of ways. The antibody can be conjugated to an enzyme, such as peroxidase, that can catalyze a color-producing reaction. Alternately, the antibody can be tagged to a fluorophore, such as fluorescein or rhodamine.

The methods described herein are suitable for any condition for which a correlation between the cell biomarker profile of a cell and the determination of a disease predisposition, diagnosis, prognosis, and/or course of treatment in samples from individuals may be ascertained. Identification of cell surface biomarkers on cells can be used to classify one or more cells in a subject. In some instances, classification includes classifying the cell as a cell that is correlated with a clinical outcome. The clinical outcome can be prognosis and/or diagnosis of a condition, and/or staging or grading of a condition. In some instances, classification of a cell is correlated with a patient response to a treatment. In some cases, classification of a cell is correlated with minimal residual disease or emerging resistance. Alternately, classification of a cell includes correlating a response to a potential drug treatment.

Often the methods and systems described herein are used for diagnosis of infection. In some instances, a first biomarker profile of cells of interest that corresponds to an infected state is compared to a second biomarker profile that corresponds to a non-infected state.

Flow cytometer instruments generally comprise three main systems: fluidics, optics, and electronics. The fluidic system may transport the cells in a stream of fluid through the laser beams where they are illuminated. The optics system may be made up of lasers which illuminate the cells in the stream as they pass through the laser light and scatter the light from the laser. When a fluorophore is present on the cell, it will fluoresce at its characteristic frequency, which fluorescence is then detected via a lensing system. The intensity of the light in the forward scatter direction and side scatter direction may be used to determine size and granularity (i.e., internal complexity) of the cell. Optical filters and beam splitters may direct the various scattered light signals to the appropriate detectors, which generate electronic signals proportional to the intensity of the light signals they receive. Data may be thereby collected on each cell, may be stored in computer memory, and then the characteristics of those cells can be analyzed based on their fluorescent and light scattering properties. The electronic system may convert the light signals detected into electronic pulses that can be processed by a computer. Information on the quantity and signal intensity of different subsets within the overall cell sample can be identified and measured.

Currently, flow cytometry can be performed on samples labeled with up to 17 or >17 fluorescence markers simultaneously, in addition to 6 side and forward scattering properties. Therefore, the data may include up to 17 or at least 17, 18, 19, 20, 21, 22, or 23 channels. Therefore, a single sample run can yield a large set of data for analysis.

Flow cytometry data may be presented in the form of single parameter histograms or as 2-dimensional plots of parameters, generally referred to as cytograms, which display two measurement parameters, one on the x-axis and one on the y-axis, and the cell count as a density (dot) plot or contour map. In some embodiments, parameters are side scattering (SSC) intensity, forward scattering (FSC) intensity, or fluorescence. SSC and FSC intensity signals can be categorized as Area, Height, or Width signals (SSC-A, SSC-H, SSC-W and FSC-A, FSC-H, FSC-W) and represent the area, height, and width of the photo intensity pulse measured by the flow cytometer electronics. The area, height, and width of the forward and side scatter signals can provide information about the size and granularity, or internal structure, of a cell as it passes through the measurement lasers. In further embodiments, parameters, which consist of various characteristics of forward and side scattering intensity, and fluorescence intensity in particular channels, are used as axes for the histograms or cytograms. In some applications, biomarkers represent dimensions as well. Cytograms display the data in various forms, such as a dot plot, a pseudo-color dot plot, a contour plot, or a density plot.

The data can be used to count cells in particular populations by detection of biomarkers and light intensity scattering parameters. A biomarker is detected when the intensity of the fluorescent emitted light for that biomarker reaches a particular threshold level.

As noted above, flow cytometry data may be analyzed using a procedure called gating. A gate is a region drawn by an operator on a cytogram to selectively focus on a cell population of interest. Gating typically starts using the light scatter intensity properties. This allows for subcellular debris to be differentiated from the cells of interest by relative size, indicated by forward scatter. This first step is sometimes called morphology. The next step may be performed to separate out doublets and clumps of cells which cannot be relied on for accurate identification, leaving only the singlets. The third step in gating may select out live cells and exclude the dead or dying cells in the population. This is usually performed using a cytogram with forward scatter as the x-axis and DAPI (4′,6-diamidino-2-phenylindole) staining intensity as the y-axis. DAPI stains the nucleus of the cell, which is only accessible in dead or dying cells, so cells showing significant DAPI stain may be deselected. Subsequent gating may involve the use of histograms or cytograms, repeatedly applied in different marker combinations, to eventually select only those cell populations that have all the markers of interest that identify that cell population.

Gate regions can take the form of polygons, squares, dividing the cytogram into quadrants or sectionals, and many other forms. In each case, the operator may make a decision as to where the threshold lies that separates the positive and negative populations for each marker. There are many variations that arise from individual differences in the sampled cohort, differences in the preparation of the sample after collection, and other sources. As a result, it is well known in the field that there is significant variation in the results from flow cytometry data gating, even between highly skilled operators.

A feature of interest can be detected by any one or more of various methods generally referred to a flow imaging microscopy (FIM). The term FIM, as used generally herein refers to methods and instruments that allow the detection of objects in a high-throughput flow system. In certain embodiments, flow cytometric methods and instrumentation may fall under the broad category of FIM generally.

FIM is capable of characterizing complex images of single subvisible particles. In FIM embodiments, a small liquid sample is pumped through a microfluidic flow-cell, and a digital microscope is used to record upwards of 10\hat{ }6 images of individual particles, such a biomolecules, and/or aggregated biomolecules, in a single experiment. A rich amount of information is encoded in this image data. FIM analysis methods to date have depended on a small number of “morphological features” (such as aspect ratio, compactness, intensity, etc.) in order to characterize the single particle images, but this short list of features (often containing highly correlated quantities) neglects a great deal of information contained in the full (RGB or grayscale) FIM images. Deep convolutional neural networks (CNNs or “ConvNets”) along with supervised or semi-supervised learning, as described herein may harness the large amount of complex digital information encoded in images and automatically extract the relevant features of interest for a given classification or fault detection task without requiring the selection, labeling, or specification of “morphological features”. In a preferred embodiment utilizing FIM, bright field, or other microscopy images are captured in successive frames as a continuous sample stream passes through a flow cell centered in the field-of-view of a custom magnification system having a well-characterized and extended depth-of-field. FIM allows not only enumerating the subvisible particles present in the sample, but also visual examination of the images of all captured particles. A standard bench-top Micro-Flow Imaging (MFI) configuration uses a simple fluidics system, where sample fluid is drawn either directly from a pipette tip or larger container through the flow cell using a peristaltic pump. The combination of system magnification and flow-cell depth determines the accuracy of concentration measurement. Concentration and parameter measurements are absolute but may be re-verified using particle standards. Typical sample volumes range from <0.25 to tens of milliliters. Frame images displayed during operation provide immediate visual feedback on the nature of the particle population in the sample. The digital images of the particles or cells present in the sample may be analyzed using image morphology analysis software that allows quantification in size and count. This system software can extract particle images using a sensitive threshold to identify pixel groups which define each particle. Successive frames, each containing many particle images, are analyzed in real time. Maximum instrument sensitivity for detecting near-transparent particles is achieved by automatically optimizing threshold values, using low-noise electronics, implementing noise reduction algorithms, and compensating for all possible non-uniformities in spatial and pulse-to-pulse illumination. Ten-bit grayscale resolution may be used to improve threshold accuracy. Images may be analyzed to compile a database containing count, size, concentration, as well as a range of shape and image contrast parameters. This database may be interrogated by the computer's application software to produce parameter distributions using histograms and scatter plots. The software supports image filtering by calculating a trial filter based on user selected representative particles and then interacting with the user to optimize this filter to extract similar particles from the total population. This feature allows particle sub-populations to be isolated and independently analyzed. Particle images are available for verification, further investigation, and analysis. Once a successful assay has been developed and validated, the resulting protocol, including run parameters, software filters, and report formats, can be saved for future use.

Direct imaging particle measurement technologies such as FIM have a number of advantages over indirect obscuration or scattering-based measurements. For example, they do not rely on a correlation between particle size and the magnitude of a scattered or obscured optical signal as calibrated using polystyrene reference beads. Provided the contrast in the particle image is sufficient for the pixels to be resolved by the system threshold, the particle will be detected and measured. No calibration by the user is required. The particle images captured by the system also provide qualitative and quantitative information about the target particle population. Qualification studies based on National Institute of Standards and Technology-traceable polystyrene beads have shown that the technology can meet high standards for sizing, concentration accuracy, and repeatability.

Non-limiting examples of commercially available FIM instruments suitable for use in the systems and methods of this disclosure include Sysmex Flow Particle Image Analyzer (FPIA) 3000 by Malvern Instruments (Worcestershire, UK), various Occhio Flowcell systems by Occhio (Angleur, Belgium), the MicroFlow Particle Sizing System by JM Canty (Buffalo, N.Y., USA), several MFI systems by ProteinSimple (Santa Clara, Calif., USA), and various Flow Cytometer and Microscope (FlowCAM) systems by Fluid Imaging (Yarmouth, Me., USA).

In the systems, methods, media, and networks described herein, deep learning (machine learning) algorithms/models may be used to analyze multidimensional flow cytometry data from a flow cytometry instrument, including raw image data from a FIM instrument. In some embodiments, the multidimensional flow cytometry data is in at least two, three, four, five, six, or seven dimensions. The multidimensional flow cytometry data may comprise one or more of the following: forward scatter (FSC) signals, side scatter (SSC) signals, or fluorescence signals. Characteristics of the signals (e.g., amplitude, frequency, amplitude variations, frequency variations, time dependency, space dependency, etc.) may be treated as dimensions as well. In some embodiments, the fluorescence signals comprise red fluorescence signals, green fluorescence signals, or both. Any fluorescence signals with other colors may be included in embodiments.

In some embodiments, the systems, methods, media, and networks described herein include identifying a gate region in the multidimensional flow cytometry data. It is difficult to define standard operating procedures to guide human operators performing manual gating. The subjective nature of manual gating often causes bias introduced by different operators and even due to a single individual operators differing performance at different times. Automated gating minimizes the variation in gating results due to cross individual variation and performance variation over time of a single operator. Computerized algorithms for flow cytometry data analysis enables more consistent gating results than the results produced by human experts. In some embodiments, supervised algorithms are employed to mimic manual gating decisions. Once configured, supervised gating algorithms produce results with substantially less variability than gating performed by human operators. Variation in gating results between different algorithms often exceeds 10%, so some embodiments consider ensembles of different algorithms to produce better gating results.

In certain embodiments, machine learning systems may include artificial neural networks (ANNs) which are a type of computational system that can learn the relationships between an input data set and a target data set. ANN name originates from a desire to develop a simplified mathematical representation of a portion of the human neural system, intended to capture its “learning” and “generalization” abilities. ANNs are a major foundation in the field of artificial intelligence. ANNs are widely applied in research because they can model highly non-linear systems in which the relationship among the variables is unknown or very complex. ANNs are typically trained on empirically observed data sets. The data set may conventionally divided into a training set, a test set, and a validation set.

In supervised learning applications, the labeled data is used to form an objective function (e.g. cross-entropy loss, “triplet” loss, “Siamese” loss, or custom loss functions encoding physical information). The network parameters are updated to optimize the specified loss function. In particular, a type of neural network called a feed-forward back-propagation classifier can be trained on an input data set to generate feature representations minimizing the cost function over the training samples. Variants of stochastic gradient descent are often used to search parameter space in combination with the back-propagation algorithm to minimize the cost function specified over the training data inputs. After a large number of training iterations, the ANN parameter updates may be stopped; the stopping criteria typically leverages evaluations of the network on the validation data set (the other stopping criteria can be applied).

The goal of training a neural network is typically to have the ANN make an accurate prediction of a new sample, for example, a sample not used during training or validation. Accuracy of the prediction is often measured against the objective function, for example, classification accuracy may be enabled by providing the truth label for the new sample. However, in one embodiment of the present inventor's method, is the use of neural networks for embedding/dimension reduction, namely takes a set large number of pixels in a source FIM image, and summarize the information content with 2-6 dimensional feature output embedding values from the ANN; the statistical distribution of the embedding point cloud is determined by nonparametric methods, and the proximity of a new set of sample “test points” is statistically tested via suitable and appropriate hypothesis tests, for example Kolmogorov-Smirnov tests, Hong and Li's Rosenblatt transform based test or Copula transform based goodness-of-fit approaches.

ANNs have been applied to a number of problems in medicine, including image analysis, biochemical analysis, drug design, and diagnostics. ANNs have recently begun to be utilized for medical diagnostic problems. ANNs have the ability to identify relationships between patient data and disease and generate a diagnosis based exclusively on objective data input to the ANN. The input data will typically consist of symptoms, biochemical analysis, and other features such as age, sex, medical history, etc. The output will consist of the diagnosis.

Disclosed herein is a novel method that presents the unprocessed FIM image data to a machine learning systems, such as an ANN for analysis that provides diagnostic, prognostic, and fault detection.

Many types of machine learning models may be employed in embodiments of inventive technology. In general, such models take as inputs one or more features of interest, such as cellular artifacts extracted from an image of a sample pass through a high-throughput system, and, with little or no additional preprocessing, they classify individual feature of interest as particular cell types, parasites, pathogens, health conditions, etc. without further intervention. In alternative embodiments, such models take as inputs one or more features of interest, such as biomolecules extracted from an image of a biopharmaceutical sample, and, with little or no additional preprocessing, they classify individual artifacts as particular biomolecule type or characteristics, such as protein aggregation. Typically, the inputs need not be categorized according to their morphological or other features for the machine learning model to classify them.

Two primary embodiments of machine learning models generally shown in FIG. 1, may include “deep” convolutional neural network (ConvNet) models and a randomized Principal Component Analysis (PCA) random forests model. However, other forms machine learning model may be employed in the context of this disclosure. A random forests model is relatively easy to generate from a training dataset and may employ relatively fewer training set members. A convolutional neural network may be more time-consuming and computationally expensive to generate from a training set, but it tends to be better at accurately classifying features of interest, such as cellular artifacts or protein aggregates.

Typically, whenever a parameter of the processing system is changed, the deep learning model is retrained. Examples of changed parameters include sample (e.g., blood) acquisition and processing, FIM instrumentation, image acquisition components, etc. Due to the machine learning based nature of the classification techniques, it is possible to upload training samples, also referred generally to as reference samples of, for example, dozens of other parasite, pathogen, or biopharmaceutical FIM images, and immediately have the model ready to identify new cell types and/or conditions.

A property of certain machine learning systems disclosed herein is the ability to classify a wide range of features of interest, such as conditions and/or cell types relevant to various biological conditions. As an example, among the types of cells or other sample features that may be classified are cells of a host and parasites or infecting pathogens of the host. Additionally, the cells of the host may be divided into various types such as erythrocytes and leukocytes. Further, host cells of a particular type may be divided between normal cells and abnormal cells such as cells exhibiting properties associated with an infection. Examples of host blood cells that can be classified include anucleated red blood cells, nucleated red blood cells, leukocytes of various types including lymphocytes, neutrophils, eosinophils, macrophages, basophils, and the like. Examples of parasites or infecting pathogens that can be present in images and successfully classified include bacteria, fungi, helminths, protozoa, and viruses. In various embodiments, the system can identify both normal cells in the host and one or more parasites or infecting pathogens of the host, including microbes that can reside in the host, and/or viruses or bacteria that can infect the host. As an example, the inventive system identified herein can classify each of erythrocytes, leukocytes, and one or more parasites, such as Plasmodium falciparum).

In these methods and systems, a machine learning system can accurately classify at least one prokaryote organism and at least one eukaryote cell type, which may be a parasite and/or a host cell. In some embodiments, a machine learning system can accurately classify at least two different protozoa that employ different modes of movement; e.g., ciliate, flagellate, and amoeboid movement. A machine learning system can accurately classify at least normal and abnormal host cells. Examples of abnormal host cells include infected cells, dysplastic cells, and metaplastic cells. In some embodiments, a machine learning system can accurately classify at least two or more sub-types of a cell. As an example, a machine learning classification model can accurately classify leukocytes into two or more of the following sub-types: eosinophils, neutrophils, basophils, monocytes, and lymphocytes. Some models can accurately identify or classify all five sub-types. In another example, the inventive machine learning system can accurately classify lymphocytes into T cells, B cells, and natural killer cells. In some embodiments, a machine learning system can accurately classify at least two or more levels of maturity or stages in a life cycle for a host cell or parasite. As an example, the inventive machine learning system can accurately classify a mature neutrophil and a band neutrophil. In each of these embodiments, a single classifier can accurately discriminate between these cell types in any sample. The classifier can discriminate between these cell types in a single image from a single sample. It can also discriminate between these cell types across multiple samples and multiple images.

In these systems and methods, a machine learning system can accurately classify both (i) normal cells in the host and (ii) one or more of parasites of the host or pathogens infecting the host. As an example, such a model can accurately classify each of red blood cells, white blood cells (sometimes of various types), and one or more parasitical/pathological entities such as fungi, protozoa, helminths, and bacteria. In these methods and systems, a model can accurately classify both normal and abnormal host cells as well as one or more parasites. As an example, the system, sometimes referred to as the model, can accurately classify normal erythrocytes and normal leukocytes, as well as an infected host cell, and a protozoan and/or bacterial cell. In an example, the model can accurately classify both a protozoan cell and a bacterial cell. For example, the protozoan cell may include one or more examples from of the babesia genus, the cytauxzoon genus, and the plasmodium genus. As a further example, the bacteria cell may include one or more of an anaplasma bacterium and a mycoplasma bacterium. In certain embodiments, the model can accurately classify erythrocytes, leukocytes, and platelets, as well as one or more parasites. In certain embodiments, the system can accurately classify erythrocytes, leukocytes, and at least one undifferentiated blood cell (e.g., a blast cell or myeloblast cell), as well as one or more parasites. In certain embodiments, the system can accurately classify erythrocytes, leukocytes, and at least a non-blood cell (e.g., a sperm cell), as well as one or more parasites/pathogens. In certain embodiments, the s can accurately classify erythrocytes and two or more types of leukocytes (e.g., two or more selected from neutrophils, eosinophils, lymphocytes, monocytes, and basophils), as well as one or more parasites.

In one example, the inventive system can accurately classify each of the following: erythrocytes, at least one type of leukocyte, at least one type of non-blood cell, at least one type of undifferentiated or stem cell, at least one type of bacterium, and at least one type or protozoa. In another example, the inventive system can classify at least the following: Erythrocytes—normal host cell (anucleated blood cell), Leukocytes—normal host cell (general), Neutrophils—normal host cell (specific type of WBC), Lymphocytes—normal host cell (specific type of WBC), Eosinophils—normal host cell (specific type of WBC), Monocytes—normal host cell (specific type of WBC), Basophils—normal host cell (specific type of WBC), Platelets—normal host cell (anucleated blood cell), Blast Cells—primitive undifferentiated blood cells—normal host cells, Myeloblast cells—unipotent stem cell found in the bone marrow—normal host cell, Acute Myeloid Leukemia Cells—abnormal host cell, Acute Lymphocytic Leukemia Cells—abnormal host cell, Sperm—normal host cell (non-blood), Parasites of the Anaplasma genus—rickettsiales bacterium that infects host RBCs—gram negative, Parasites of the Babesia genus—protozoa that infects host RBCs, Parasites of the Cytauxzoon genus—protozoa that infects cats, Mycoplasma haemofelis—bacterium that infects cell membranes of host RBCs—gram positive, Plasmodium Falciparum—protozoa that is a species of malaria parasite; infects humans and produces malaria, Plasmodium vivax—protozoa that is a species of malaria parasite; infects humans and produces malaria, Plasmodium ovale—protozoa that is a species of malaria parasite (rarer than falc and vivax); infects humans and produces malaria, Plasmodium malariae—protozoa that is a species of malaria parasite; infects humans and produces malaria but less severe than falc and vivax.

In some cases, the system may be trained to classify cells of different levels of maturity or different stages in their life cycles. For example, certain leukocytes such as neutrophils have an immature form known as band cells which may be identified by multiple unsegmented nuclei connected to the central region of the cell. The distance and connection structure between the peripheral lobes, with unsegmented nuclei, and the central region may indicate the level of maturity of the cells. An increase in band neutrophils typically means that the bone marrow has been signaled to release more leukocytes and/or increase production of leukocytes. Most often this is due to infection or inflammation in the body.

Certain aspects of the inventive technology provide a system and method for identifying a sample feature of interest in a sample, such as a biological sample of a host organism. In some embodiments, the sample feature of interest is associated with a disease. The system includes a FIM instrument to capture digital images of the biological sample and one or more processors communicatively connected to an image capturing device, such as a camera—which may be part of a FIM instrument in some embodiments. In some embodiment, the one or more processors of the system are configured to perform a method for identifying a sample feature of interest. In some embodiments, the one or more processors of the system are configured to receive the one or more images of the biological sample captured by the FIM instrument. The one or more processors are optionally configured to segment the one or more images of the biological sample to obtain a plurality of images of the individual components of the sample passing through, in this embodiment a high-throughput FIM instrument.

In some embodiments, a segmentation operation may be applied which may include converting the one or more images of the biological sample from color images to grayscale images. Various methods may be used to convert the one on one or more images from color images to grayscale images. In some embodiments, the grayscale images are further converted to binary images using an Otsu thresholding method.

In some embodiments, the binary images may be transformed using a using a Euclidean distance transformation method as further described elsewhere herein. In some embodiments, the segmentation further involves identifying local minima of pixel values obtained from the Euclidean distance transformation. The local minima of pixel values indicate central locations of potential cellular artifacts. In some embodiments, the segmentation operation also involves applying a Sobel filter to the one or more images of the biological sample. In some embodiments, the gray scale images are used. Data obtained through the Sobel filter accentuate edges of potential cellular artifacts.

In some embodiments, segmentation further involves splicing the one or more images of the biological sample using the local maxima and data obtained from applying the Sobel filter, thereby obtaining a plurality of images of the cellular artifacts. In some applications, each spliced image includes a cellular artifact. In some embodiments, the splicing operation is performed on color images of the biological sample, thereby obtaining a plurality of images of the cellular artifacts in color. In other embodiments, gray scale images are spliced and used for further classification analysis.

In some embodiments, each of the plurality of images of the cellular artifacts is provided to a machine-learning classification system to classify a feature of interest. In some embodiments, the machine-learning system includes a neural network model. In some embodiments, the neural network model includes a convolutional neural network model. In some embodiments, the machine-learning classification model includes a principal component analysis and a Random Forests classifier.

In some embodiments where the machine-learning system includes principal component analysis and a random forests classifier, each of the plurality of images of the feature of interest, such as a cellular artifact, is standardized and converted into, e.g., a 50×50 matrix, each cell of the matrix being based on a plurality of image pixels corresponding to the cell. This conversion helps to reduce the total amount of data to be analyzed. Different matrix sizes can be used depending on the desired computational speed and accuracy.

The system may include two or more modules in addition to a segmentation module. For example, images of individual features of interest may be provided by the segmentation module to two or more machine learning modules, each having its own classification characteristics. In certain embodiments, machine learning modules are arranged serially or pipelined. In such embodiments, a first machine learning module receives individual features of interest and classifies them coarsely. A second machine learning module receives some or all of the coarsely classified features of interest and classifies them more finely.

As mentioned, the reduced data of the plurality of images of the cellular artifacts may undergo dimensional reduction using, e.g., PCA. In some embodiments, the principal component analysis includes randomized principal component analysis. In some embodiments, about twenty principle components are obtained. In some embodiments, about ten principal components are obtained from the PCA. In some embodiments, the obtained principal components are provided to a random forests classifier to classify the cellular artifacts.

In certain embodiments, a systems having a neural network, e.g., a convolutional neural network, takes as input the pixel data of cellular artifacts extracted through segmentation. The pixels making up the cellular artifact are divided into slices of predetermined sizes, with each slice being fed to a different node at an input layer of the neural network. The input nodes operate on their respective slices of pixels and feed the resulting computed outputs to nodes on a next layer of the neural network, which layer is deemed a hidden layer of the neural network. Values calculated at the nodes of this second layer of the network are then fed forward to a third layer of the neural network where the nodes of the third layer act on the inputs they receive from the second layer and generate new values which are fed to a fourth layer. The process continues layer-by-layer until values reach an output layer containing nodes representing the separate classifications for the input cellular artifact pixels. As an example, one node of the output layer may represent a normal cell, another node of the output layer may represent an infected cell, yet another node of the output layer may represent, for example, an anucleated red blood cell, and yet still a further output node may represent a malarial parasite. After execution of the classification, each of the output nodes may be probed to determine whether the output is true or false. A single true value classifies the input cellular artifact.

Typically, the various layers of a convolutional neural network correspond to different levels of abstraction associated with the classification process. For example, some inner layers may correspond to classification based on a coarse outer shape of a feature of interest, such as a cellular artifact, for example circular, non-circular ellipsoidal, sharp angled, etc., while other inner layers may correspond to a different aspect or separate feature of interest, such as the texture of the interior of the cellular artifact, a smoothness of the perimeter of the cellular artifact, etc. In general, a plurality of rules governing which layers conduct which particular aspects of the classification process may be implemented. The training of the neural network may simply define nodes and connections between nodes such that the model more accurately classifies a feature of interest like cellular artifacts from an image of a biological sample.

Deep convolutional neural networks may include multiple feed forward layers. As known to those of skill in the art, these layers aim to extract relevant features from an input image; the features extracted depend on the objective function used for training. The convolutional layer's parameters include a set of learnable filters (or kernels), which have a small receptive field, but are applied to the entire input image region in the convolution step. In certain embodiments, during the forward pass, each filter is convolved across the width and height of the input image, computing a type of dot product between the entries of the filter and the input and producing an activation map associated with that filter. As a result, the network learns filters that activate when they encounter some specific type of feature at some spatial position in the input. The resulting activation maps are processed in both standard feed forward fashion and using “skip connections” in conjunction with feed forward output.

Convolutional networks may include local or global pooling layers, which reduce the dimensionality of the activation maps. They also include various combinations of convolutional, fully connected layers, skip connections, and customized layers, for example squeeze excite, residual blocks, or spatial transformer subnetworks. The neural network may include various combinations of feed forward stacked layers in order to generate feature representations of the input image data. The specific nature of the estimated features depends on the objective function, the input data, and the neural network architecture selected.

In certain embodiments, the deep learning image classification model may employ TensorFlow. Routines available from Google of Mountain View, Calif. or may employ PyTorch routines available from Facebook of Menlo Park, Calif. Some embodiments may employ VGG style network architectures, Google's simplified Inception net architecture, or multiscale Dilated Residual Networks (DRN). Modules like the Squeeze Excite or Spatial Transformer subnetworks may be inserted in the aforementioned networks using standard loss or custom loss functions.

Various types of conditions, such as medical conditions or the condition of biomolecules, may be identified using systems and methods of this disclosure. For example, the simple presence of a pathogen or unexpected (abnormal) cell associated with a condition (e.g., a disease or disorder) may be a condition. In other embodiments, biomolecule conditions, such as protein aggregates in a biopharmaceutical sample may be identified and/or characterized. In these methods, the direct output from the machine learning model provides a condition, namely the model may identify a feature of interest, such as a cellular artifact of a parasite or infecting pathogen. Other conditions may be obtained indirectly from the output of the model. For example, some conditions may be associated with an unexpected/abnormal cell count or ratio of cell/organism types. In such cases, the direct outputs of the invention, such as classifications of multiple features of interest, such as cellular artifacts, are compared, accumulated, etc. to provide relative or absolute numbers of cellular artifact classes. In these methods, the invention may provide at least one of two main types of diagnosis: positive identification of a specific organism, or cell type, or biomolecule, and quantitative analysis of cells or organisms classified as a particular type or of multiple types, whether host cells or non-host cells.

For example, one class of host cell quantitation counts leukocytes. Cell count information may be absolute or differential (e.g., ratios of two different cell types). As an example, an absolute red blood cell counts lower than a reference range is considered anemic. Certain immune-related conditions consider absolute counts of leukocytes (e.g., of all types). In one example, absolute counts greater than about 30,000/ml indicate leukemia or other malignant condition, while counts between about 10,000 and about 30,000 indicate a serious infection, inflammation, and/or sepsis. A leukocyte count of greater than about 30,000/ml may suggest a biopsy for example. At the other end of the range, leukocyte counts of less than about 4000/ml suggest leukopenia. Neutrophils (a type of leukocyte) may be counted separately; absolute counts less than about 500/ml suggests neutropenia. When such condition is diagnosed, the patient is seriously compromised in her ability to fight infection and she may be prescribed a neutrophil boosting treatment. In one embodiment, a white blood cell counter uses image analysis as described herein and provides a semi-quantitative determination of white blood cells count in capillary or venous whole blood. The determinations are Low (below 4,500 WBCs/μL), Normal (between 4,500 WBCs/μL and 10,000 WBCs/μL) and High (greater than 10,000 WBCs/μL).

In some cases, leukocyte differentials or ratios are used to indicate particular conditions. For example, ratios or differential counts of the five leukocyte types represent responses to different types of conditions. For example, neutrophils primarily address bacterial infections, while lymphocytes primarily address viral infections. Other types of white blood cell include monocytes, eosinophils, and basophils. In some embodiments, eosinophil counts greater than 4-5% of the WBC populations are flagged for allergic/asthmatic reactions to a stimulus.

Other examples of conditions associated with differential counts of the various types of leukocytes (e.g., neutrophils, lymphocytes, monocytes, eosinophils, and basophils) include the following conditions:

The condition of an abnormally high level of neutrophils is known as neutrophilia. Examples of causes of neutrophilia include but are not limited to: acute bacterial infections and also some infections caused by viruses and fungi; inflammation (e.g., inflammatory bowel disease, rheumatoid arthritis); issue death (necrosis) caused by trauma, major surgery, heart attack, burns; physiological (stress, rigorous exercise); smoking; pregnancy—last trimester or during labor; and chronic leukemia (e.g., myelogenous leukemia).

The condition of an abnormally low level of neutrophils is known as neutropenia. Examples of causes of neutropenia include but are not limited to: myelodysplastic syndrome; severe, overwhelming infection (e.g., sepsis—neutrophils are used up); reaction to drugs (e.g., penicillin, ibuprofen, phenytoin, etc.); autoimmune disorder; chemotherapy; cancer that spreads to the bone marrow; and aplastic anemia.

The condition of an abnormally high level of lymphocytes is known as lymphocytosis. Examples of causes of lymphocytosis include but are not limited to acute viral infections (e.g., hepatitis, chicken pox, cytomegalovirus (CMV), Epstein-Barr virus (EBV), herpes, rubella); certain bacterial infections (e.g., pertussis (whooping cough), tuberculosis (TB)); lymphocytic leukemia; and lymphoma.

The condition of an abnormally low level of lymphocytes is known as lymphopenia or lymphocytopenia. Examples of causes of lymphopenia include but are not limited to autoimmune disorders (e.g., lupus, rheumatoid arthritis; infections (e.g., HIV, TB, hepatitis, influenza); bone marrow damage (e.g., chemotherapy, radiation therapy); and immune deficiency.

The condition of an abnormally high level of monocytes is known as monocytosis. Examples of causes of monocytosis include but are not limited to chronic infections (e.g., tuberculosis, fungal infection); infection within the heart (bacterial endocarditis); collagen vascular diseases (e.g., lupus, scleroderma, rheumatoid arthritis, vasculitis); inflammatory bowel disease; monocytic leukemia; chronic myelomonocytic leukemia; and juvenile myelomonocytic leukemia.

The condition of an abnormally low level of monocytes is known as monocytopenia. Isolated low-level measurements of monocytes may not be medically significant. However, repeated low-level measurements of monocytes may indicate bone marrow damage or hairy-cell leukemia.

The condition of an abnormally high level of eosinophils is known as eosinophilia. Examples of causes of eosinophilia include but are not limited to asthma, allergies such as hay fever; drug reactions; inflammation of the skin (e.g., eczema, dermatitis); parasitic infections; inflammatory disorders (e.g., celiac disease, inflammatory bowel disease); certain malignancies/cancers; and hypereosinophilic myeloid neoplasms.

The condition of an abnormally low level of eosinophils is known as eosinopenia. Although the level of eosinophil is typically low, its causes may still be associated with cell counts under certain conditions.

The condition of an abnormally high level of basophils is known as basophilia. Examples of causes of basophilia include but are not limited to rare allergic reactions (e.g., hives, food allergy); inflammation (rheumatoid arthritis, ulcerative colitis); and some leukemias (e.g., chronic myeloid leukemia).

The condition of an abnormally low level of basophils is known as basopenia. Although the level of basophils is typically low, its causes may still be associated with cell counts under certain conditions.

Each of the above conditions may be generally referred to as a medical condition as generally used herein. To diagnose a condition, the image analysis results (positive identification of a cell type or organism and/or quantitative information about numbers of cells of organisms) may be used in conjunction with other manifestations of the condition such as a patient exhibiting a fever. As another example, the diagnosis of leukemia can be aided by high counts of non-host cells such as bacteria. Generally, as infections get more severe, the counts increase.

The embodiments disclosed herein may be implemented as a system for topographical computer vision through automatic imaging, analysis and classification of physical samples using machine learning techniques and/or stage-based scanning. Any of the computing systems described herein, whether controlled by end users at the site of the sample or by a remote entity controlling a machine learning model, can be implemented as software components executing on one or more general purpose processors or specially designed processors such as programmable logic devices (e.g., Field Programmable Gate Arrays (FPGAs)) and/or Application Specific Integrated Circuits (ASICs) designed to perform certain functions or a combination thereof. In some embodiments, code executed during operation of image acquisition systems and/or machine learning models (computational elements) can be embodied by a form of software elements which can be stored in a nonvolatile storage medium (such as optical disk, flash storage device, mobile hard disk, cloud-based systems etc.), including a number of instructions for making a computer device (such as personal computers, servers, network equipment, etc.). Image acquisition algorithms, machine learning models and/or other computational structures described herein may be implemented on a single device or distributed across multiple devices. The functions of the computational elements may be merged into one another or further split into multiple sub-modules.

The hardware device can be any kind of device that can be programmed including, for example, any kind of computer including smart mobile devices (watches, phones, tablets, and the like), personal computers, powerful servers or supercomputers, or the like. The device includes one or more processors such as an ASIC or any combination processors, for example, one general purpose processor and two FPGAs. The device may be implemented as a combination of hardware and software, such as an ASIC and an FPGA, or at least one microprocessor and at least one memory with software modules located therein. In various embodiments, the system includes at least one hardware component and/or at least one software component. The embodiments described herein could be implemented in pure hardware or partly in hardware and partly in software. In some cases, the disclosed embodiments may be implemented on different hardware devices, for example using a plurality of CPUs equipped with GPUs capable of accelerating scientific computation.

Each computational element may be implemented as an organized collection of computer data and instructions. In certain embodiments, an image acquisition algorithm and a machine learning model can each be viewed as a form of application software that interfaces with a user and with system software. System software typically interfaces with computer hardware, typically implemented as one or more processors (e.g., CPUs or ASICs as mentioned) and associated memory. In certain embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

At one level a computational element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor may be structural. In other words, the instructions per se may include a series of symbols or numeric values. They do not intrinsically convey any information. It is the processor, which by design was preconfigured to interpret the symbols/numeric values, which imparts meaning to the instructions.

In certain embodiments, the modules or systems generally used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines not suitable for mobile or field operations. Such operations may be implemented on hardware remote from the site where the sample is processed, for example on a server or server farm connected by a network to a field device that captures the sample image, or through a cloud-based network. Less computationally intensive operations may be implemented on a portable or mobile device used in the field for image capture.

Various divisions of labor are possible: for example, a mobile device used in the field may contain processing logic to coarsely discriminate between leukocytes, erythrocytes, and pathogens, and optionally to provide counts for each of these. In some cases, the processing logic includes image capture logic, segmentation logic, and course classification logic, with the latter optionally implemented as a random forest model. These logic components may be implemented as relatively small blocks of code that do not require significant computational resources. Logic that executes remotely (e.g., on a remote server or even supercomputer) discriminates between different types of leukocyte. As an example, such logic can classify eosinophils, monocytes, lymphocytes, basophils, and neutrophils. Such logic may be implemented as a deep learning convolutional neural network and require relatively large blocks of code and significant processing power. With the leukocytes or parasites or pathogens correctly identified, the system may additionally execute differential models for diagnosing conditions based on differential amounts of various combinations of the five leukocyte types.

The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention.

### EXAMPLES

The following methods were used to conduct the experiments described in the Examples below:

### Example 1: Detection and Identification of Microbial Infections of Blood

The high level of magnification offered by recently commercialized flow imaging microscopy instruments allows flow microscopes to record images of particles as small as 200 nm. The present inventors have discovered that this ability, when combined with ConvNets, can be used to image, detect and classify bacteria and other types of cells and particles, such as biomolecules. Thus, in one embodiment, the combination of FIM and ConvNets can be applied to detecting microbial infections of blood. Current approaches for detecting blood infections rely predominantly on blood culture, a technique in which a blood sample is grown in media to promote microbial growth. If an organism grows in the media, the sample typically is tested using standard microbiological approaches to identify the type of microbe. This approach takes a significant amount of time in order to obtain a diagnosis; samples frequently require 24-48 hours for an organism to be culture to detectable levels and additional time to identify the pathogen. Additionally, this approach often requires large blood volumes (multiple mL) in order to reliably detect pathogens. These drawbacks are particularly significant for neonates who need rapid identification and treatment of any potential blood infections and can only have <1 mL of blood drawn from them in order to diagnose an infection. FIM and ConvNets can be combined to mitigate to detect microbial infections in approximately one hour of analysis with minimal blood volume from the patient.

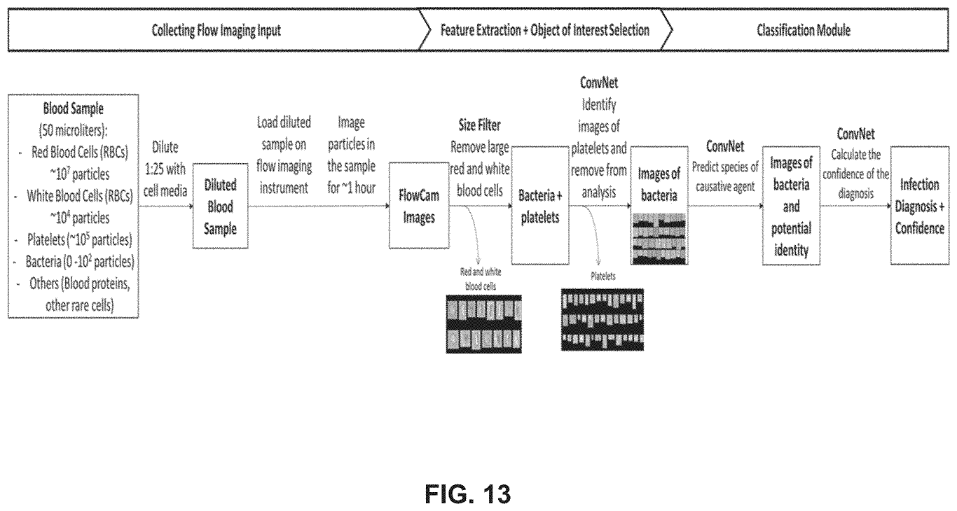

The proposed strategy for detecting bloodstream infections utilizes flow imaging to image individual components, such as cells in a biological sample, preferably a blood sample and apply machine learning systems as described herein to detect pathogenic cells within that blood sample. FIG. 1 generally illustrates an exemplary preferred embodiment using these two technologies to identify pathogenic cells in a 50 μL blood sample with roughly 1 hour of analysis time. FIG. 13 illustrates a preferred embodiment for detecting bloodstream infections. In this embodiment, a blood sample is diluted with isotonic media and analyzed with a flow imaging microscopy (FIM) instrument capable of imaging particles smaller than 2 μm. Images potentially containing pathogenic species can then be isolated from the FIM data (1) by applying a combination of particle size filters and convolutional neural networks (ConvNets) to identify images of large blood cells (e.g. red and white blood cells) and smaller blood cells (e.g. platelets), respectively, and remove them from subsequent stages in the analysis. Once images potentially containing a pathogen are isolated, the present inventors can use an additional ConvNet to predict an identity of the pathogen. Finally, the present inventors may further use a final ConvNet trained via a fault detection, embodied in a fault detection module (5) approach to estimate the confidence that the algorithm identified the correct pathogen in the previous step.

To demonstrate the various steps shown in FIG. 13, in one embodiment, the present inventors collected training data sets of murine blood samples and several bacteria species samples frequently encountered in neonatal sepsis cases. For blood samples, roughly 200 μL of blood was placed in a 2 mL microcentrifuge tube containing 1 mL of Dulbecco's modified Eagle's Media (DMEM) with 0.5 mM/mL EDTA. 0.5 mL of this solution were diluted to 5 mL with DMEM to obtain low concentrations of blood that would yield high quality images during FIM. FIM was performed using a FlowCam Nano system, a flow imaging instrument that uses oil immersion to obtain images of objects smaller than 2 μm. 0.25 mL of the diluted blood sample were analyzed at a time at a flow rate of 0.01 mL/min. Before beginning measurements, fresh immersion oil was added to the system optics and the background intensity of the instrument was adjusted to approximately 150 in order to minimize the effect of background artifacts between measurements.

Six species of bacteria were imaged to generate a training dataset using FIM; Enterococcus faecalis, Staphylococcus aureus, Pseudomonas aeruginosa, Klebsiella pneumoniae, Escherichia coli, and Acinetobacter baumannii. All organisms were clinically isolated strains. Each organism was incubated overnight in cation-adjusted Muller Hinton Broth (CAMHB) and then subcultured in fresh CAMHB for 3 hours prior to imaging. At the time of imaging these samples were diluted 1:10 with DMEM and then analyzed using FIM. Due to biosafety requirements, the FlowCam Nano system was moved into a biological safety cabinet prior to taking measurements. Otherwise the same protocol used to image blood samples was used to image each organism.

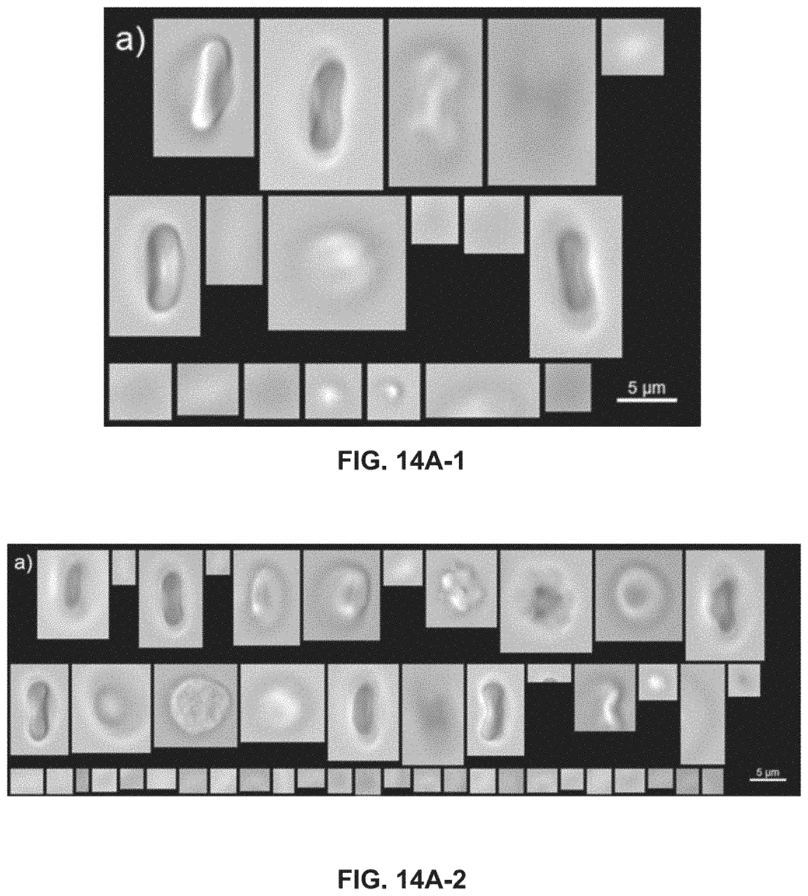

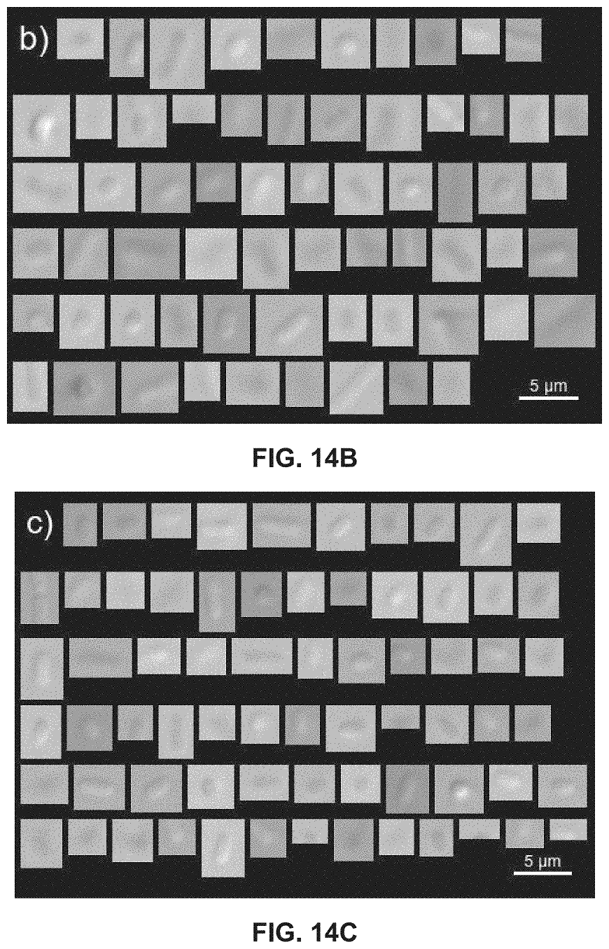

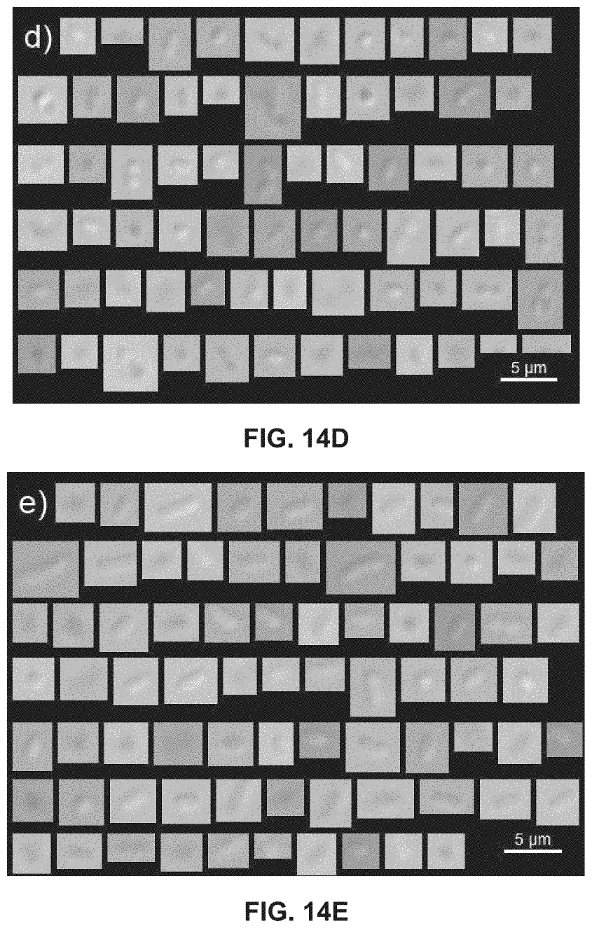

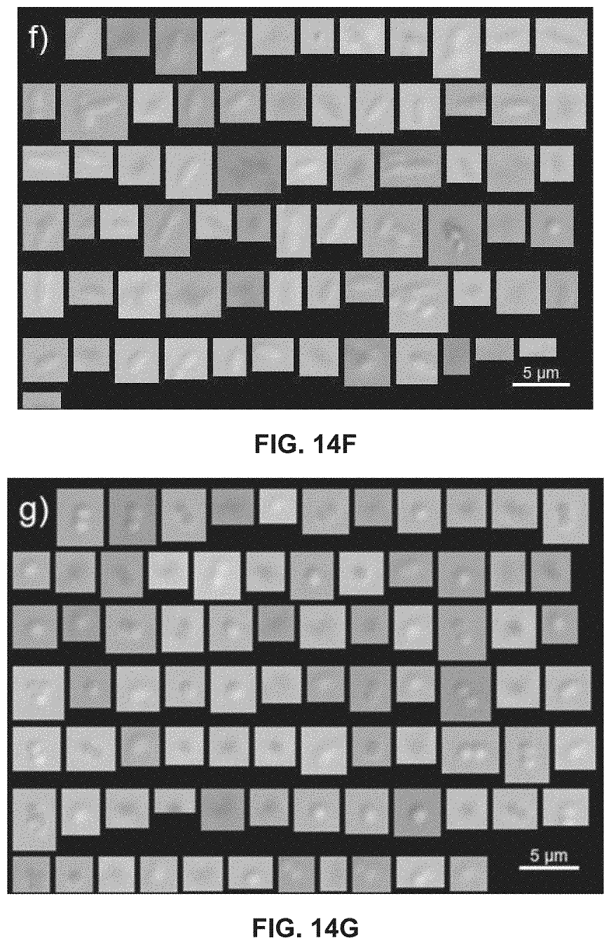

FIG. 14A-G shows example images of blood and the different organisms collected using a FIM instrument with optics appropriate for this embodiment. As shown by these FIM image collages, many of the different cell types that may be encountered in a blood sample can be visually distinguished from each other. For example, the larger blood cells in FIG. 14A can easily be distinguished from the much smaller microbes in FIG. 14B-G. Individual microorganisms can also generally be distinguished by their morphology; the single, rod-shaped E. coli cells in FIG. 14C can be distinguished from chains of spherical S. aureus cells in FIG. 14G. ConvNets can use these visual differences between different cells to identify which organism is present in FIM images in an automated manner. Additionally, these networks can also learn to distinguish even more visually similar organisms such as differentiating between E. coli in FIG. 14(c) and K. pneumoniae in FIG. 14(e).

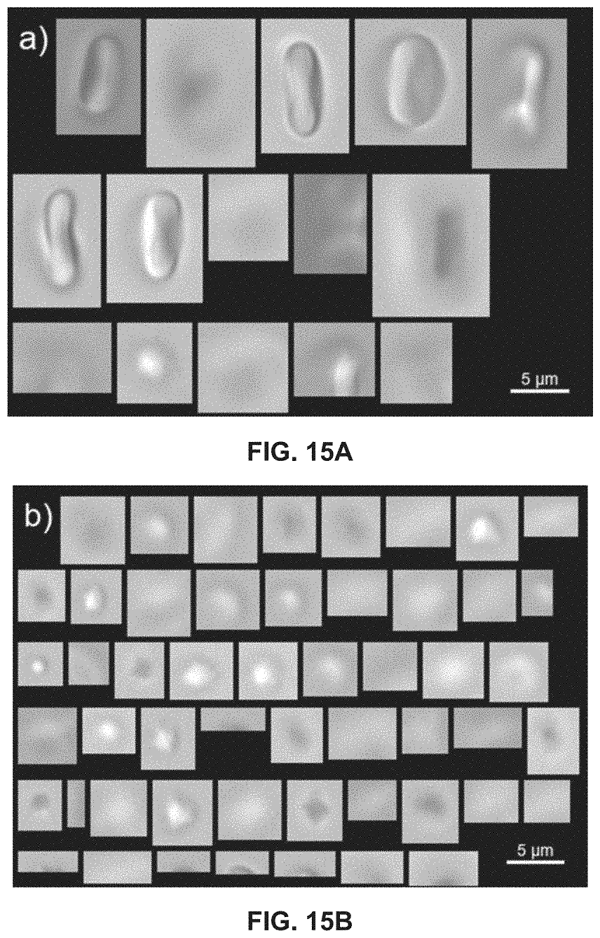

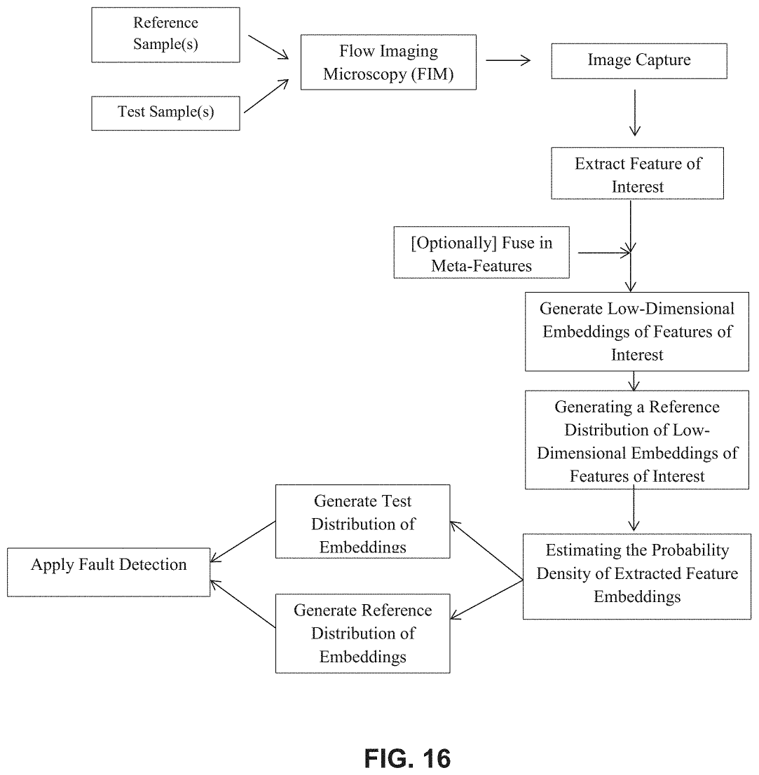

In the first two stages of analysis, FIM images containing blood cells are identified and excluded from subsequent stages of the analysis. The first stage is designed to remove images of red blood cells which make up the majority of images collected during FIM. Since red blood cells (RBCs) are significantly larger than typical pathogenic cells (˜7 μm vs ˜2 μm), a simple size threshold can be used to identify the large RBCs. In this approach, the size of each cell may be estimated using off-the-shelf commercial software and cells the size of RBCs or larger are identified and removed. This approach removes all RBCs as well as white blood cells (WBCs) in the sample with minimal impact on pathogenic cells. To demonstrate, large RBCs and WBCs were removed from blood samples using a 5 μm size threshold. FIG. 15A shows typical images of blood cells filtered out by this threshold while FIG. 15B shows blood cells that remain after the size filter.

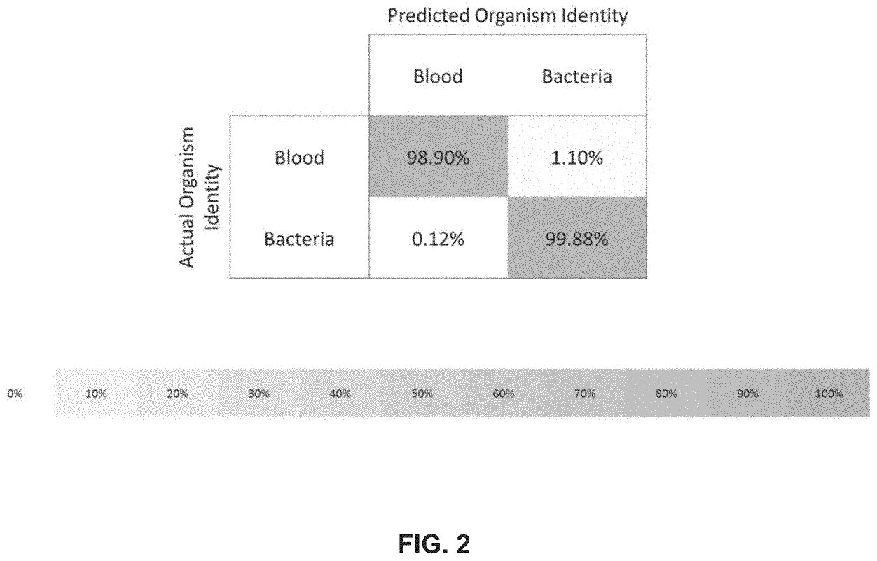

In the second stage of the analysis, a ConvNet is used to remove images of platelets and other small blood particles, isolating images likely to contain pathogen. A ConvNet can be used to distinguish between images of blood cells remaining after the previous size threshold and images of various pathogen species. FIG. 2 shows the performance of a ConvNet trained in this manner on images of blood and bacteria not used to train the network. The ConvNet can, with high confidence, correctly identify if a given FIM image contains platelets and other small blood particles or one of the pathogenic cells the network was trained against. Using a combination of size thresholds and this ConvNet, most of the blood cells from the initial sample can be correctly identified and excluded from the analysis. All of the remaining images after these processing steps are likely to contain a pathogenic cell.

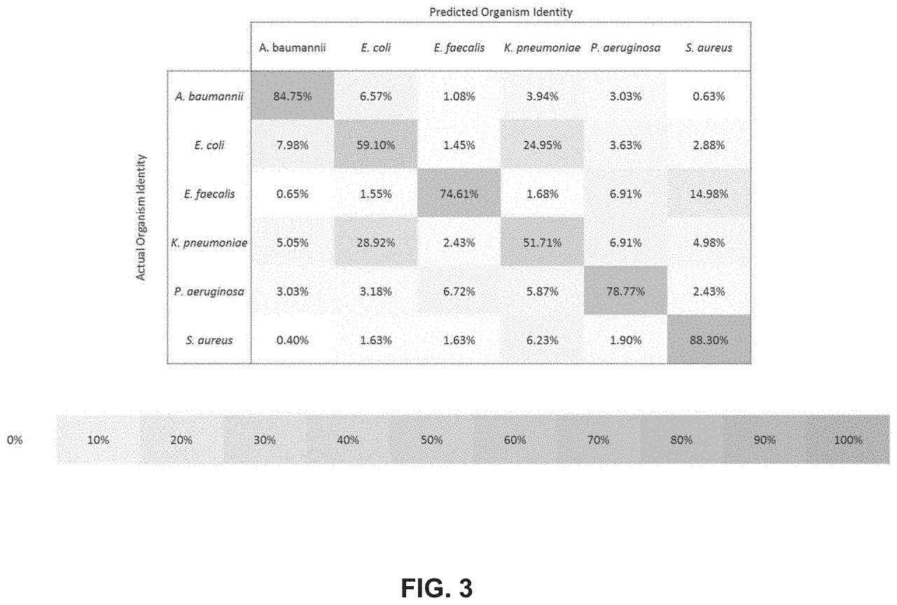

After removing most of the images of blood cells, the present inventors can use a second ConvNet to analyze the remaining images to identify a candidate pathogen. FIG. 3 shows the accuracy of a ConvNet trained to identify several exemplary organisms encountered in neonatal sepsis cases. Although two organisms (E. coli and K. pneumoniae) are slightly more difficult for the network to distinguish, on average the network correctly identifies the organism in a single FIM image 73% of the time with images of four of the six organism being correctly identified by the network >75% of the time. It is important to note that the accuracy indicated in FIG. 3 is on a single image of a pathogen isolated from a blood sample. While in many small blood samples with low concentrations of bacteria a diagnosis may need to be made on a single image, in larger samples or samples with higher concentrations multiple images of the pathogen may be recovered. The accuracy of this approach improves rapidly as more images of the pathogen are recovered.

In the final stage of the analysis, the present inventors can calculate the confidence of the diagnosis obtained in the previous step using a fault detection approach. In this step, the remaining images from the current sample are compared to images of the identified organism using the ConvNet-based fault detection approach to establish how confident the algorithm is both in the diagnosis of sepsis and the identity of the causative agent. This final step allows the algorithm to distinguish between samples that contain the identified pathogen and those that contain artifacts that were confused for the identified pathogen. Additionally, this step helps distinguish between morphologically similar organisms similar (e.g. E. coli vs other rod-shaped bacteria) that otherwise may be confused for each other in previous stages of the analysis.

After the analysis is complete, this approach may return a diagnosis of sepsis, the predicted identity of the causative agent, and the confidence in the diagnoses. Additionally, the approach yields images of any objects in the blood sample that were identified as potentially being pathogenic. These images give clinicians a method to check the raw data collected in the analysis before accepting the diagnosis and beginning treatment.

The primary benefits of this approach are its sensitivity to trace amounts of pathogenic cells even in small blood samples. Since FIM allows direct analysis of every cell in a blood sample, this approach can identify blood samples from a patient with a bloodstream infection or sepsis in cases where the sample only contains a few pathogenic cells. This sensitivity allows the inventive technology to accurately analyze even small blood samples such as those available from neonatal patients. Importantly, the sensitivity of this allows the elimination of the 24-48 culture step that is required with many other techniques for diagnosing bloodstream infections and instead look for pathogenic cells directly from the blood sample. While other techniques such as those based on flow cytometry or polymerase chain reactions (PCR) can also eliminate this culture step, many of these approaches rely on organism-specific labels or primers to achieve the sensitivity needed to detect pathogenic cells without relying on cell culture. The inventor's proposed approach does not require labeling to detect trace amounts of any pathogenic cells that may be in a given sample.

The sensitivity of the algorithm relaxes the amount of time and blood volume needed to perform the analysis. Each step of the proposed analysis can be performed quickly; sample preparation takes negligible time to perform, ConvNet analysis can be completed in a few seconds after the networks are trained, and FIM can be completed in one hour for a 50 μL blood sample. This novel approach can diagnose sepsis in approximately one hour—significantly faster than the 24-72 hours required for blood culture as well as the 4-8 hours required for many PCR-based approaches. Additionally, this approach does not require large blood samples from the patient to detect pathogenic species and is designed to give an accurate sepsis diagnosis even from a single drop of blood. The minimal volume and analysis time requirement make this approach ideal for diagnosing neonatal sepsis. Larger blood samples may also be analyzed using this approach, increasing the analysis time due to the extra volume but yielding more reliable detection of trace concentrations of the pathogen.

### Example 2: Identifying Microbial Infections of Urine and Other Body Fluids

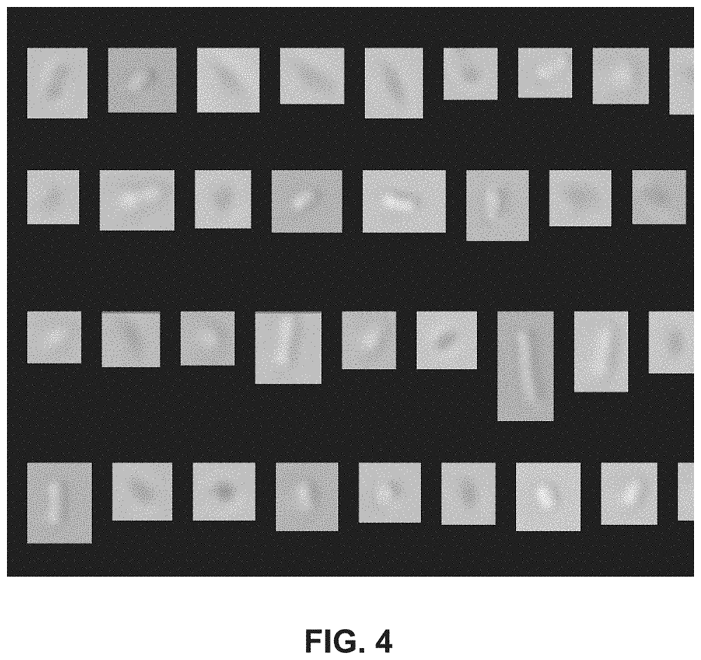

As with blood infections, the same general algorithm shown in FIG. 1 can be used to diagnose infections from other types of samples, for example murine samples, vaginal swabs. In these applications, ConvNets may be trained to distinguish between pathogens and the particles typically present in that fluid instead of just blood cells. Since many of these samples contain minimal background particles it is significantly easier to diagnose infections of these fluids than blood. In one embodiment, the present inventors have shown that the novel flow imaging microscopy and ConvNet approach described herein allows rapid identification of foreign organisms in urine—a feature previously confirmed using suspensions of E. coli in simulated urine solutions. FIG. 4 shows sample FIM images obtained from this analysis.

### Example 3: Identifying Changes in Gene Expression in Cells

In certain embodiments, the invention also combines flow imaging microscopy and machine learning algorithms to monitor mammalian, bacterial, fungal, and insect cells used to produce biomolecules in the pharmaceutical industry. In such manufacturing processes, cells engineered to express the biomolecule of interest such as a protein, are grown in culturing vessels for periods of hours to weeks. It is critical that these cells retain and express the genes necessary to produce the protein of interest for the duration of the operation. Expression of genes within cells changes their chemical composition, and because changes in chemical composition in turn influence the refractive index and light scattering properties of cells, flow microscopy images reflect fingerprint signatures of even subtle changes in gene expression levels, which the ConvNet algorithm can be trained to detect. ConvNet analysis of flow microscopy images may thus be sensitive enough to changes in cell structure to allow monitoring of expression levels of these recombinant genes within large populations of cells. In this embodiment, a ConvNet may be trained on reference samples to generate images of a cell line used in a manufacturing process such as mammalian cells such as Chinese hamster ovary cells, bacterial cells such as E. coli, yeast cells, or insect cells both with and without the gene encoding the target protein. Samples produced during the manufacturing process can then be imaged using flow microscopy to identify the number of cells expressing the protein as well as other features of the cell population such as viability.

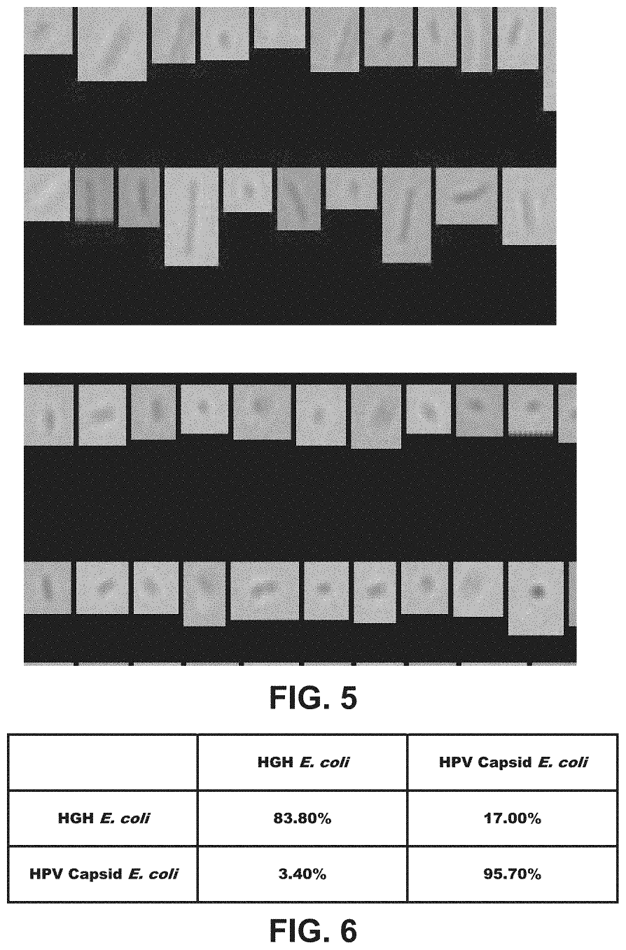

To demonstrate that ConvNets analysis of FIM images is sensitive to even minor genetic changes between cells, the present inventors used FIM to image two strains of E. coli; one expressing human growth hormone (hGH) and the other expressing the capsid proteins for the human papillomavirus (HPV). These strains were imaged using a FlowCam VS and used to train a simple 4-layer ConvNet to differentiate between the two strains. FIG. 5 shows example FIM images of these organisms. FIG. 6 shows the performance of the ConvNet classifier as a confusion matrix.

### Example 4: Detecting Upsets in Therapeutic Protein Formulation Manufacturing

In one preferred embodiment, ConvNets for monitoring protein aggregates and other particles produced during the manufacture of therapeutic protein formulations may be detected and classified. Protein aggregates and other particles in protein formulations are a significant safety concern during manufacturing due to their association with severe and potentially fatal adverse effects in the clinic. Because it is difficult to completely remove particles from these solutions, it is essential for companies producing these therapies to monitor these particles in their product to ensure that the concentration and structure of particles present in each vial matches product specifications. Although a variety of techniques are used to monitor the number and size distributions of particle, no currently used approach allows for rapid monitoring of particle morphologies, or classification of these morphologies according to the mechanism by which particles were formed, or their relative safety risk to patients. If such tools were available, it would be possible to detect changes in particle structure that could compromise the efficacy of the product. Furthermore, because such changes in particle morphology arise due to upstream process upsets, techniques for monitoring subvisible particle morphology could be used to quickly detect these upsets to preserve the quality of the product.

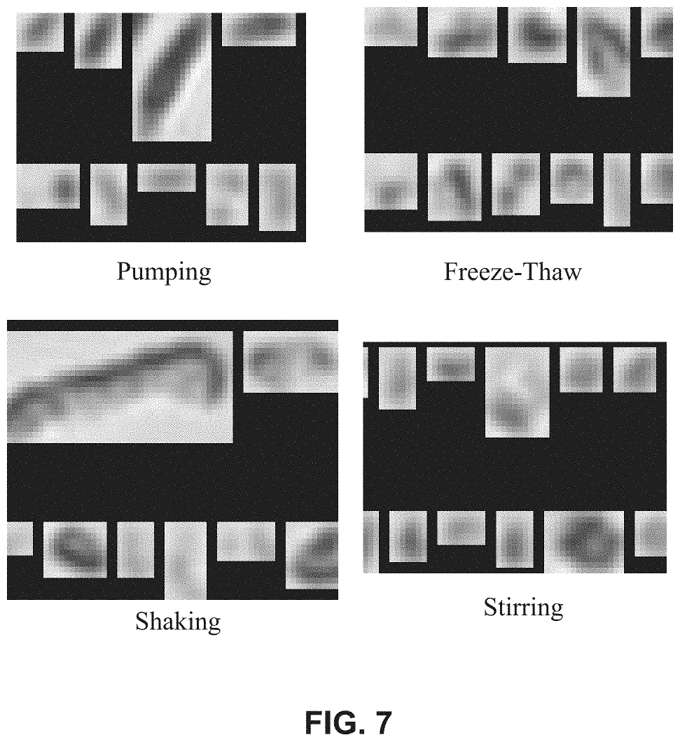

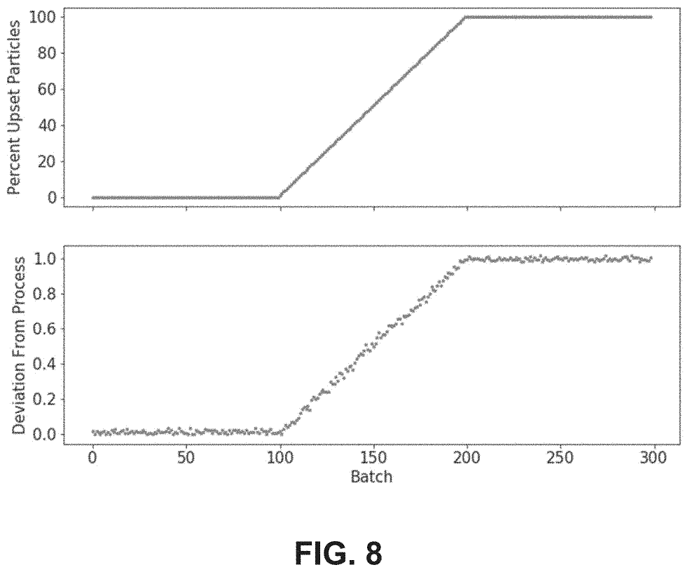

To demonstrate this embodiment, the present inventors trained a ConvNet to identify aggregates of a polyclonal antibody generated by a model fill finish operation against particles made by two model process upsets: freeze-thaw stress and shaking stress. FIG. 7 shows FIM images of particles generated via each mechanism obtained from a grayscale MFI 5200 FIM instrument. The network in this application consists of three convolutional layers. This network was trained on samples to differentiate between particles generated via each mechanism in the training set using a triplet loss approach. The present inventors applied the trained network to synthetic FIM datasets containing particles generated by our model fill-finish process to simulate particles generated under normal process conditions. The network was then applied to synthetic FIM datasets containing mixtures of particles normally generated by the above process and particles generated by a stirring stress (a particle types the network was not shown during training) in different ratios to simulate a process upset. FIG. 8 shows the response of the network to synthetic FIM datasets mimicking standard operating conditions and an upstream process upset.

To demonstrate that the system can distinguish between multiple antibody types in combination with various stresses, the present inventor sought to detect aggregates generated by a monoclonal antibody (specifically IgG1) and a polyclonal antibody subjected to numerous stresses: a “pH” stress meant to mimic bulk solution stresses that would be experienced in a viral clearance step, as well as a shaking and freeze-thaw stresses. Color FIM images of these proteins were measured with a FlowCam VS device.

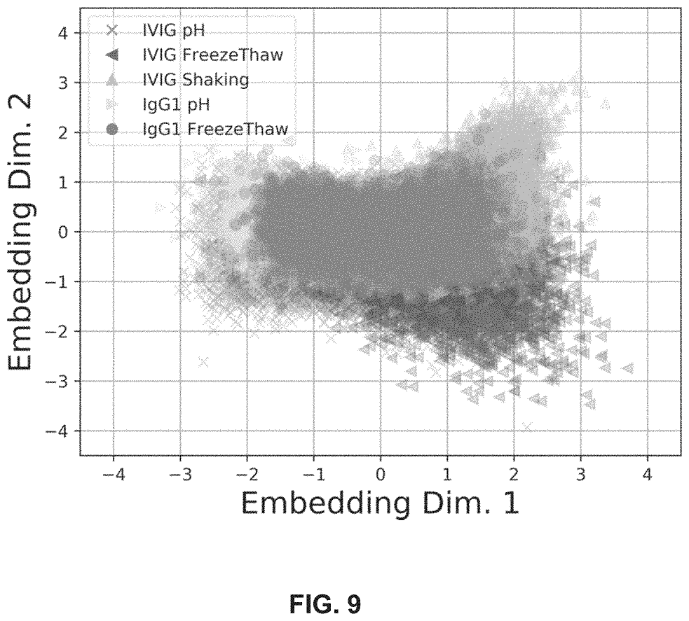

In the results associated with FIG. 9-FIG. 12, the ConvNet in the “ConvNet Feature Extraction Module” (2) uses a standard VGG style network with Squeeze & Excite modules added. Parameters of the network were obtained using a novel custom cost function aiming to encode biophysical information in the output embedding (this cost function aims to separate bulk vs. interface stresses and monoclonal vs. polyclonal antibodies). The cost function used to define the biophysically inspired embedding in this embodiment takes the following form:

$$\frac{1}{N} {\sum }_{i = 1}^{C} {\sum }_{j = 1}^{N} {1}_{{C}_{i}} ( {x}_{j} ) {‖ {x}_{j} - {c}_{i} ‖}_{2}^{2}$$

(Formula I) where C represents the net number of labeled classes in the training set, N represents the total number of training samples, xⱼ represents the CNN embedding representation of image j, 1_{c}_{ᵢ}(xⱼ) represents the indicator function for the sample xⱼ belonging to class label “i”, cᵢ represents a input parameter (with same dimensions as the embedding) specifying the desired cluster center for class “i” samples, and represents ∥x∥₂ the standard Euclidean norm of the vector x. The biophysical information is encoded by suitably specifying the cᵢ parameters. The embeddings resulting from this “ConvNet Feature Extraction Module” (using explicitly labeled data) and antibody types are shown in FIG. 9. The embedding shown in FIG. 9 serve as the basis for illustrating the novel Fault Detection embodiments of the inventive method, but other ConvNet architectures and cost functions could be entertained. For this embodiment, the “Fusion Module” (3) and “Object of Interest Selection Module” (4) may represent simply the identification function.

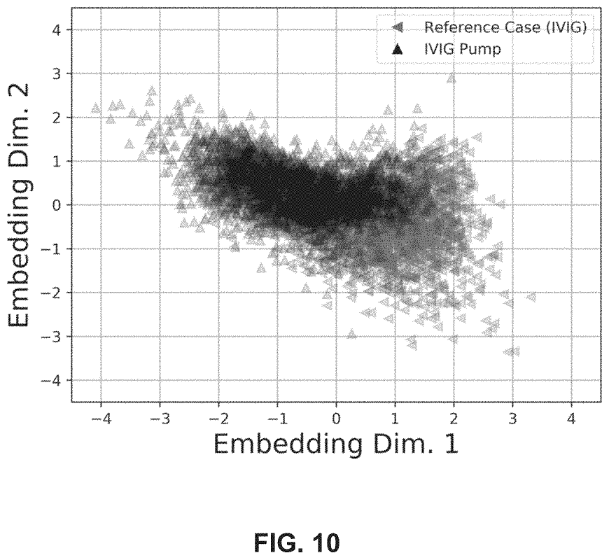

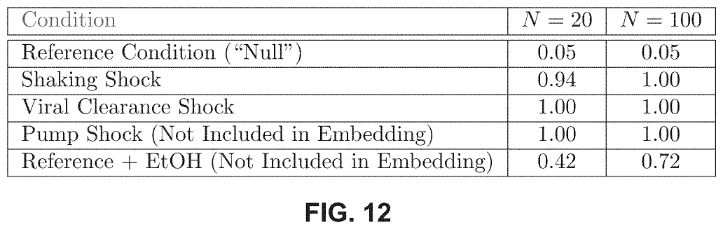

The below embodiment describes the “Fault Detection Module” in more detail. Specifically, in FIG. 10, the present inventors graphically demonstrate the ability of the system to detect a priori unanticipated process upsets induced by changing manufacturing equipment (specifically, the embeddings shown by upward pointing dark triangles represent embeddings resulting by evaluating the “ConvNet Feature Extraction Module” (2) trained on the data shown in FIG. 9 on new data formed by processing a polyclonal antibody with a new pump type). The present inventors took polyclonal Freeze-Thaw as a Reference condition to demonstrate the ability to graphically detect this type of new particle in a control chart (in FIG. 12, the present inventors demonstrate formal hypothesis testing methods quantifying similarity of particles to this reference condition).

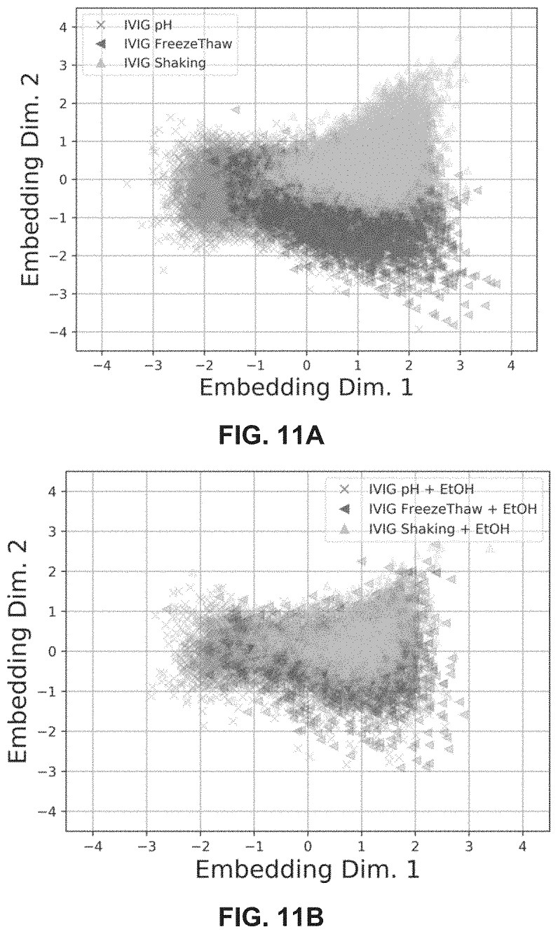

In FIG. 11A, the present inventors focus on the polyclonal embeddings generated from the system in the training set obtained by washing vials with distilled water (the monoclonal classes in the training are omitted for clarity). In FIG. 11B, the present inventors show the same stresses and polyclonal antibodies, but this time formed with protein obtained using vials washed with trace amounts of ethanol. This class represents a new shock not explicitly included in our embedding framework. Specifically, FIG. 11B graphically demonstrates how the trace ethanol coating on the vial affects the embedding shape. It is worth noting that the effect of ethanol is concentrated on the surface of the container and influences the embeddings of the two surface stresses (shaking where aggregation is believed to form by an air-water interface and freeze-thaw where aggregates are believed to form at the ice-water interface with ice formation primarily occurring on the solid glass vial due to the nature of heat transfer in the Freeze-Thaw shock used). The ability to detect differences in aggregates formed in containers having different surface chemistry is particularly important given the fact that changes in protein vial types have been known to cause adverse drug responses in protein therapeutics. The embedding applied to this second set of unanticipated process stresses (i.e. those not included in the embedding training) demonstrate the ability to graphically detect this type of new particle in a control chart FIG. 12, demonstrates the formal hypothesis testing methods quantifying similarity of particles to this reference condition).

Again, referring to FIG. 12, the present inventors quantified the ability of the Fault Detection method to detect departures from a reference distribution of embeddings. In this embodiment, the present inventors used polyclonal IVIG Freeze-Thaw stress as a reference case or “null” given a small collection FIM images from the conditions discussed above. In this embodiment of our “Fault Detection Module”, the present inventors utilized a Gaussian nonparametric kernel to estimate the two-dimensional density of the embeddings points under the training reference condition (though any other parametric or nonparametric approach can be used to empirically estimate this density). For new observations where it is desired to quantify the similarity of the embedding distribution to the reference case, the present inventors use the estimated nonparametric density to evaluate the Rosenblatt transformation of the multivariate embedding; under the reference or null condition, the transformed variables should be uniform and identically distributed multivariate random variables. The present inventors further tested the uniform shape using the Kolmogorov-Smirnov (KS) goodness-of-fit test (though other Copula transformations in combination with other hypothesis tests such as Hong and Li's 2005 “omnibus” or Remillard's 2012 method can be used for the goodness-of-fit testing in alternative embodiment) under the null to empirically determine the goodness-of-fit test statistic distribution for each samples size of interest. FIG. 12 reports the size and power of this procedure obtained by taking random samples of size 20 and 50 and conducting the KS test under the various null and null alternative conditions (the table reports the average rejection rate obtained after analyzing 10,000 Monte Carlo samples of size N where N is 20 or 50 with a target type I error rates of 5% for each condition; although the present inventors report the 5% alpha or type I error rate results, it should be note that the method outputs p-values so any type I error rate can be entertained with the inventive approach. Further, it should be explicitly noted that in the case labeled “Reference Condition”, the present inventors used the polyclonal IVIG Freeze-Thaw stress protocol to generate aggregates (null or Reference Condition samples), but the FIM images analyzed here were not contained in the training dataset (the images were obtained from a vial held out from the training set); this dataset is meant to intend that it is possible to achieve the target type I error (false alarm) using new images not leveraged in the training of the ConvNet carrying out the embedding. The cases labeled “Shaking Shock” and “Viral Clearance Shock” were explicitly modeled stress conditions in FIG. 9, and the remaining cases (with embeddings shown in FIG. 10 and FIG. 11) were not explicitly accounted for in the embedding model, but both could be readily detected using only 50 image samples.

The various features and processes described above may be used independently of one another or may be combined in various ways. All possible combinations and subcombinations are intended to fall within the scope of this disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

1. A method of applying machine learning to detect and analyze particles in liquid suspensions in high-throughput systems comprising:
training a neural network having multiple layers using a training dataset comprising:
at least one reference dataset generated by passing a reference sample comprising particles in a liquid suspension through a high-throughput flow imaging instrument and extracting features of interest from a plurality of images from the reference sample, and optionally, one or more additional reference datasets generated by passing one or more additional samples comprising additional liquid suspensions of particles resulting from contaminants or process upsets through said high-throughput flow imaging instrument and capturing a plurality of images of the individual components passing through said high-throughput flow imaging instrument and extracting features of interest from said plurality of images from said one or more additional samples;
generating a reference distribution by embedding the extracted features of interest from said plurality of images from said at least one reference sample to convert the extracted features of interest to a lower dimensional feature set and optionally generating one or more additional reference distributions by embedding the extracted features of interest from said plurality of images from the one or more additional samples to convert the extracted features of interest to a lower dimensional feature set defined by using a loss function to separate the embedded lower dimensional feature sets associated with each reference distribution;
estimating the probability density of the individual extracted feature embeddings of said lower dimensional feature population distribution outputs from the reference sample and optionally, estimating the probability density of one or more of the additional samples on the embedding space;
obtaining a test dataset by passing a test sample through a high-throughput flow imaging instrument and capturing a plurality of images of the individual components passing through said high-throughput flow imaging instrument and extracting features of interest from a plurality of images from said test sample, generating a test distribution of the embedded extracted features of interest from said plurality of images from said test sample; and
applying a fault detection algorithm to evaluate if a test distribution of embeddings from a test sample is consistent with a population density of features of interest by quantitatively comparing the statistical similarity of the test distribution of embeddings against said reference distribution of embeddings or said one or more additional reference distributions of embeddings, or evaluating if said test distribution of embeddings does not correspond to an a priori known population density distribution of embeddings.

2. The method of claim 1, wherein the particles in the liquid suspensions of particles comprise particles selected from the group consisting of: aggregated protein molecules, biopharmaceutical formulations, particles in drinking water, microcrystalline particles, and microcrystalline particles in drinking water.

3. (canceled)

4. The method of claim 1, wherein the plurality of images of the individual components passing through said high-throughput flow imaging instrument comprises 10 to 10⁷ images of the individual components passing through said high-throughput flow imaging instrument.

5. The method of claim 1, wherein said liquid suspensions comprises biopharmaceutical formulations subject to one or more contaminants or process upsets selected from the group consisting of: a biopharmaceutical sample subjected to freeze-thawing, a biopharmaceutical sample subjected to shaking, a biopharmaceutical sample subjected to stirring, a biopharmaceutical sample subjected to elevated temperature, a biopharmaceutical sample subjected to cold stress, a biopharmaceutical sample subjected to chemical stress, a biopharmaceutical sample subjected to radiation, a biopharmaceutical sample subjected to pumping, a biopharmaceutical sample subjected to vibration, a biopharmaceutical sample subjected to mechanical shock, a biopharmaceutical sample subjected to contamination and combinations thereof.

6. The method of claim 2, wherein said aggregated protein molecules comprise aggregated protein molecules generated by a pharmaceutical fill-finish operation.

7. The method of claim 1, and further comprising applying a fusion module incorporating features determined by other modalities to generate more additional features of interest or additional extracted feature embeddings.

8-9. (canceled)

10. A method of applying machine learning to detect and analyze characteristics of cell phenotypes in high-throughput systems comprising:
training a neural network having multiple layers using a training dataset comprising:
at least one reference dataset generated by passing a reference sample comprising cells in a liquid suspension through a high-throughput flow imaging microscopy instrument and extracting features of interest from a plurality of images from the reference sample and optionally, one or more additional reference datasets generated by passing one or more additional samples comprising additional cells in a liquid suspension and wherein said cells in a liquid suspension contain or are contaminated with cells of different phenotypes, or cells subjected to process upsets, or cells with different genotypes, through said high-throughput flow imaging instrument and capturing a plurality of images of the individual components passing through said high-throughput flow imaging instrument and extracting features of interest from said plurality of images from the one or more additional samples;
generating a reference distribution by embedding the extracted features of interest from said plurality of images from said at least one reference sample to convert the extracted features of interest to a lower dimensional feature set, and optionally generating one or more additional reference distributions by embedding the extracted features of interest from said plurality of images from the one or more additional samples to convert the extracted features of interest to a lower dimensional feature set defined by using a loss function intending to separate the embedded lower dimensional feature sets associated with each reference distribution;
estimating the probability density of the individual extracted feature embeddings of said lower dimensional feature population distribution outputs from the reference sample and optionally, estimating the probability density of one or more of the additional samples on the embedding space;
optionally obtaining a test dataset by passing a test sample through a high-throughput flow imaging instrument and capturing a plurality of images of the individual components passing through said flow imaging instrument and extracting features of interest from a plurality of images from said test sample, generating a test distribution of the embedded extracted features of interest from said plurality of images from said test sample; and
optionally applying a fault detection algorithm to evaluate if a test distribution of embeddings from a test sample is consistent with a population density of features of interest by quantitatively comparing the statistical similarity of the test distribution of embeddings against said reference distribution of embeddings or said one or more additional reference distributions of embeddings, or evaluating if said test distribution of embeddings does not correspond to an a priori known population density distribution of embeddings.

11. The method of claim 10, wherein said reference sample comprises cells in a liquid culture having a consistent or homogenous phenotype.

12. The method of claim 10, wherein said reference sample comprises cells in a liquid culture expressing a heterologous protein or nucleotide sequence.

13. The method of claim 10, wherein said additional cells comprises cells selected from the group consisting of: cells subjected to differential growth conditions, cells subjected to differential nutrient conditions, cells having lost some or all of a heterologous expression plasmid vector, cells having suppressed transcription of heterologous nucleotides; cells having suppressed translation of heterologous peptides, cells having suppressed transcription of endogenous nucleotides, cells having suppressed translation of endogenous peptides, cells having newly synthesized DNA, cells having newly synthesized RNA, cells expressing differential surface proteins, contaminating cells of a different cell type, and cells expressing differential biomarkers.

14. The method of claim 10, and further comprising applying a fusion module incorporating features determined by other modalities to generate additional features of interest or additional extracted feature embeddings.

15. A method of applying machine learning to detect and analyze cells and microbial pathogens in biological samples in high-throughput systems without individual pathogen labeling comprising:
training a neural network having multiple layers using a training dataset comprising:
at least one reference dataset generated by passing a reference sample comprising cells in a biological sample through a high-throughput flow imaging microscopy instrument and extracting features of interest from a plurality of images from said reference sample, and optionally, one or more additional reference datasets generated by passing one or more additional samples comprising additional liquid suspensions of cells resulting from infection, or contamination, or a disease state, through said high-throughput flow imaging instrument and capturing a plurality of new images of the individual cells passing through said high-throughput flow imaging PM instrument and extracting features of interest that are predictive of cell types, that are similar to the cells of said reference dataset, from said plurality of new images from said one or more additional samples, wherein the predictive cell types are classified by using one or more of the features and/or cell type labels in a classification system;
optionally generating a reference distribution by embedding the extracted features of interest from said plurality of images from the reference sample to convert the extracted features of interest to a lower dimensional feature set, and further optionally, generating one or more additional reference distributions by embedding the extracted features of interest from said plurality of images from the one or more additional samples to convert the extracted features of interest to a lower dimensional feature set defined by using a loss function intending to separate the embedded lower dimensional feature sets associated with each reference distribution; and
optionally estimating the probability density of the individual extracted feature embeddings of said lower dimensional feature population distribution outputs from the reference sample and optionally, estimating the probability density of one or more of the additional samples on the embedding space.

16. The method of claim 15, wherein the biological sample comprises a biological sample selected from the group consisting of: sputum, oral fluid, amniotic fluid, blood, a blood fraction, bone marrow, a biopsy samples, urine, semen, stool, vaginal fluid, peritoneal fluid, pleural fluid, tissue explant, mucous, lymph fluid, organ culture, cell culture, or a fraction or derivative thereof or isolated therefrom.

17. The method of claim 15, and further comprising applying a fusion module incorporating features determined by other modalities to generate more additional features of interest or additional extracted feature embeddings.

18. The method of claim 15, wherein said extracted feature of interest is correlated with a known disease condition.

19. The method of claim 18, wherein said disease condition comprises sepsis.

20. The method of claim 18, wherein said disease condition is associated with the type and/or quantity of said extracted feature of interest, or with the type and/or quantity of cells found in the biological sample.

21. (canceled)

22. The method of claim 15, wherein said biological sample comprises a blood sample.

23. The method of claim 22, wherein said wherein said blood sample optionally comprises a blood sample having a volume of 25 to 100 microliters.

24. The method of claim 22, and further comprising the step of applying a exclusion application, such exclusion application optionally including an estimated particle size-based or neural network-based classifier, to said blood sample to exclude cells in said blood sample above a size or feature-based threshold wherein said cells in said blood sample above a threshold size comprises red blood cells, white blood cells, and platelets.

25. (canceled)
